(19) United States
(12) Patent Application Publication
(10) Pub. No.: US 2003/0177140 A1
(43) Pub. Date: Sep. 18, 2003

(54) Method for developing application programs using program constructs

(75) Inventors: Davis M. Debard, La Crescenta, CA (US); Andrew K. Wanzenberg, Northridge, CA (US)

Correspondence Address: SIDLEY AUSTIN BROWN & WOOD LLP, 717 NORTH HARWOOD, SUITE 3400, DALLAS, TX, 75201, US

(73) Assignee: Answer Financial, Inc.

(21) Appl. No.: 09/795,716

(22) Filed: Feb. 28, 2001

(51) Int. Cl. G06F 17/00

(52) U.S. Cl. 707/104.1

(57) ABSTRACT

A method for using a computer system to develop an application program and a method for collecting information from an end-user are disclosed. The method for developing the application program includes the steps of defining a set of discrete program constructs, a data dictionary wherein data elements are associated with at least one of the constructs, and a standardized interaction between the constructs. The constructs can be assembled, without the use of a programming language, into a sequence to form the application program. The standardized interaction is based in part on a position of the construct in the sequence. Multiple unique application programs can be constructed that share information by sharing a single data dictionary, thus allowing the construction of applications which can reduce or eliminate the need to answer the same question more than once.

### FIELD OF THE INVENTION

The present invention relates to a method for creating interactive computer applications using discrete program constructs. This system, referred to herein as “Kinetix Technology,” reduces the amount of programming time and effort necessary to create interactive computer applications, and improves the efficiency of interactive information exchange between such applications and the end-users of such applications. This invention is particularly well suited to exchanging information between Internet web sites and their users.

### BACKGROUND OF THE INVENTION

Interactive data exchange between computer programs and end-users continues to evolve. In the 1960's, programs read in a file of data and operated on that data until the program was complete. Such programs, running without immediate involvement of the end-user are not considered interactive. Intelligence (the computer program) was primarily separate from the data. Interaction with the computers consisted of submitting commands and letting the computer perform the commands.

In the 1970's, databases, word processors, spreadsheets, and other applications were developed for personal computers, leading to a substantial increase in interactivity as the end-user could interact immediately with the applications. Intelligence began to be associated with the data itself. Data types such as character, numeric, date, etc., had certain “built-in” validations. Databases increased their offerings of validation technology.

By the 1980's, object-oriented languages such as C++ enabled programmers to very specifically model the relationship between data and intelligence, therefore providing a more substantial relationship than mere data validation. For example, an “automobile” object might have “make,” “model,” and “year” attributes, each with custom validations. Data and the intelligence applied to it are now closely coupled, but at the expense of significant programming time, as each object has its own unique interface, which must be hand-coded.

The 1990's saw the rise of the Internet, and essentially a return to the mainframe style architecture (one logical server, many clients) Temporarily, web pages returned to the 1960's style of programming, functions applied to data, with little immediate interactivity. While the platform shifted from personal computers to the Internet, programming techniques were not the main focus of development.

In the 2000's, more advanced programming techniques are required. Custom development of interactive web, client-server, and other applications continues to be expensive, labor intensive, and difficult. Typical end-user interface objects, such as textboxes, have attributes pertaining to their appearance (spatial) and their content (validation, etc.). These objects are isolated from one another, and an external program compels objects to relate to one another. The program requires considerable and expensive human involvement to manipulate complex interfaces, such as those of C++ objects. A substantial amount of testing is still required for even relatively simple applications. A simpler, more standardized set of application building blocks is needed; one that closely couples data and intelligence, as with C++ objects, but without the complex and necessarily hand-coded interfaces of C++.

The development process for complex software should be simple, straightforward, and segmented for maximum speed to market and overall effectiveness of expensive and limited resources. To conserve bandwidth and more effectively utilize resources, server access should be limited to the minimum required. To increase end-user satisfaction, applications should simplify the data input process by eliminating redundant entry of the same information and superfluous information requests. One of the principal requirements in an interactive application or service is to keep the process simple, easy, and relevant to the end-user. Major factors in providing good customer service are to ask a minimal number of questions, thereby reducing the time and workload on the end-user. This can be accomplished by eliminating questions that are redundant or irrelevant to a particular end-user.

For example, a single set of questions may be asked of all users requesting an auto insurance quote. Because the information required for preparing the auto insurance quote in a “no-fault” state is different from that in a state which is not a “no-fault” state, some end-users of current applications are required to enter data that is irrelevant to their specific insurance quotes. A smart application, one that requests only the information required from a particular end-user, is clearly preferable.

### SUMMARY OF THE INVENTION

The present invention provides a method, referred to herein as “Kinetix Technology,” for building application programs that dynamically collect and present data, process data, and present results of such processing through an end-user interface. Pages presented to the end-user at an end-user terminal are dynamically updated, based on previous interactive responses and programmed rules. Kinetix Technology also provides for pre-filling certain information, based upon responses to previous questions, in anticipation of the end-user's response. The pre-filled information can be confirmed or corrected by the end-user The net result is a method of gathering only the information actually required for processing a end-user inquiry, thereby simplifying data input.

A “Kinetix System” is one or more Kinetix and a single defining Data Dictionary, operating within the Kinetix Technology application framework. A “Kinetix” comprises a sequence of discrete program constructs, each of which is referred to herein as a “tic,” operating within a framework of predefined actions and relationships (Kinetix Technology), and fitting together to cause anticipated but customized outcomes.

A Kinetix System uses a single Data Dictionary to maintain data integrity and assure that duplicate or inconsistent data is absent. While databases have offered this security for years, it is new that these safeguards are extended to the application environment without the need for additional programming constructs.

A Kinetix System will interact with three levels of users. At the most fundamental level, a “programmer” develops tics, the building blocks of a Kinetix Application. The programmer will have programming skills with a programming language (the C or C++ language, for example). At the next higher level, a “Kinetix-developer” will assemble complete applications from existing tics. At the highest level is the “end-user,” who will use the completed application to perform a task, such as applying for life insurance. Neither the Kinetix-developer nor the end-user requires programming language skills.

The Kinetix-developer may implement validations within a Kinetix System. These determine the acceptability of the end-user's response for each question. Invalid responses are flagged, and if necessary, a corrected response is requested. Validations may be performed on the server- or client-side. When validations are performed on the client side and all responses in a particular page are determined to be valid, a “page break” tic returns the validated data to the server. The page break tic also triggers the dynamic creation of the next page based upon the upstream (previously entered) information.

The Kinetix System automatically and dynamically customizes the end-user's interaction for higher efficiency. These dynamically-created pages request only the information actually required from the individual end-user, by tailoring downstream content via rules acting on preceding end-user data inputs The process of creating a set of questions, prompting for and pre-filling tic information, and validating the end-user's responses can be repeated as many times as necessary.

The dynamic creation of the tic questions and the flow from one tic to the next are based upon criteria predetermined by the Kinetix-developer. These criteria define what information is needed for any given process, and what constitutes a valid response. These criteria also determine how one Kinetix differs from another, although many Kinetix can be based upon the same library of tic types.

Kinetix Technology draws from preceding programming approaches, but offers advantageous new features. The key benefit of Kinetix Technology is that, unlike object-oriented programming, the interaction between tics is simple and predetermined, allowing them to merely be assembled, rather than custom programmed. Data and its intelligence are closely coupled without custom coding requirements. Further, traditional programming constructs, such as textboxes, radio buttons, etc. have existed in a contextual isolation with no concept of how the program sequence impacts the construct or is impacted by the construct. Tics, on the other hand, “run.” Many formatting aspects are based on the position of tics within a Kinetix. A tie value can change based on the tic's location. Similar to the object-oriented concept of “inheritance,” which changes object functionality based on parent object behavior, the behavior of tics can be changed simply by moving them in a Kinetix, a less complex approach to implement.

### BRIEF DESCRIPTION OF THE DRAWINGS

For a better understanding of the present invention, reference is made to the following Detailed Description, taken in conjunction with the following drawings in which:

FIG. 1 is a schematic illustration of a computer implemention of the present invention,

FIG. 2 is a schematic illustration of a network implemention of the present invention,

FIG. 3 is a schematic illustrating how multiple Kinetix may link to a single Data Dictionary,

FIG. 4 illustrates typical rule tics,

FIG. 5 illustrates an end-user's screen view of the life insurance Kinetix illustrated in FIG. 3,

FIG. 6 illustrates the operation of the health insurance Kinetix “in-line” rule,

FIG. 7 illustrates a end-user's initial screen view of the health insurance Kinetix,

FIG. 8 illustrates how an in-line rule modifies the end-user's display with the addition of detailed questions,

FIG. 9 is a flow diagram illustrating the server side of a Kinetix Application,

FIG. 10 is a flow diagram illustrating validation logic flow,

FIG. 11 is a flow diagram illustrating output logic,

FIG. 12 is a flow diagram illustrating the client (browser) side of a Kinetix Application,

FIG. 13 is a further illustration of Server-Client Kinetix interaction,

FIG. 14 is an example of a Kinetix-developer screen, showing the implementation of a “display text” type tic within an “Auto Insurance” Kinetix,

FIG. 15 is an example of a Kinetix-developer screen, showing the implementation of an “input textbox” type tic within an “Auto Insurance” Kinetix,

FIG. 16 is an example of a Kinetix-developer screen, showing the implementation of another “input textbox” type tic within an “Auto Insurance” Kinetix,

FIG. 17 is an example of a Kinetix-developer screen, showing the implementation of an “input textbox” type tic within an “Auto Insurance” Kinetix,

FIG. 18 shows how the tics added to the “Auto Insurance” Kinetix (FIGS. 14 through 17) are positioned into a display,

FIG. 19 is an example of a Kinetix-developer screen, showing implementation of an “impact” input-type tic,

FIG. 20 is an example of a Kinetix-developer screen, showing implementation of the rule governing the tic shown in FIG. 19,

FIG. 21 is an example of a Kinetix-developer screen, showing how the rule creates a relationship between condition tics and impact tics,

FIG. 22 shows how the tics added to the “Auto Insurance” Kinetix (FIGS. 19 and 20) modify the display (FIG. 18),

FIG. 23 is an example of a Kinetix-developer screen, showing implementation of a “style template” type tic,

FIG. 24 is an example of a Kinetix-developer screen, showing implementation of a “style progress” type tic,

FIG. 25 is an example of a Kinetix-developer screen, showing implementation of a hosted “animated assistance” type Kinetix,

FIG. 26 is an example of an end-user screen, composed of the tics selected by the Kinetix-developer, as shown in FIGS. 14, 15, 16, 17, 19, 20, 21, 23, 24, and 25,

FIG. 27 is an example of a “KINETIX_TYPE” table,

FIG. 28 is an example of a “KINETIX” table,

FIG. 29 is an example of a “DATA_TYPE” table,

FIG. 30 is an example of a “DATA_DICTIONARY” table,

FIG. 31 is an example of a “VALIDATION” table

FIG. 32 is an example of a “TIC_TYPE” table,

FIG. 33 is an example of a “TIC” table,

FIG. 34 is an example of a “STYLE” table,

FIG. 35 is an example of a “GRAPHIC” table,

FIG. 36 is an example of a “TEXT_POSITION” table,

FIG. 37 is an example of a “RULE” table,

FIG. 38 is an example of a “RULE_CONDITION” table,

FIG. 39 is an example of a “RULE_IMPACT” table,

FIG. 40 is an example of a “RESPONSE” table,

FIG. 41 is an example of a “USER” table,

FIG. 42 is an example of a “RESPONSE_DATA” table, and

FIG. 43 is an example of a “RESPONSE_RULE” table.

### DETAILED DESCRIPTION OF THE PREFERRED EMBODIMENTS

“Kinetix Technology” is a general term used to describe a method for management and presentation of interactive content. Kinetix Technology allows interactive computer applications (application programs) to be created using program constructs. Kinetix Technology also provides a method for presenting data to and collecting data from the end-user.

The name “Kinetix” is taken from “kinetic energy,” meaning “characterized by motion,” because a Kinetix interacts dynamically with both the Kinetix-developer and the end-user. The Kinetix-developer creates a Kinetix by inserting tics one by one. As each tic is inserted, the other tics accommodate the insertion in a sense by “moving.” With respect to using the application, portions of the Kinetix “downstream” of the end-user move and change according to Kinetix rules acting on data previously entered by the end-user.

A “Kinetix System” is one or more Kinetix Applications sharing a single defining Data Dictionary and operating within the Kinetix Technology framework. For example, a Kinetix System may include a Kinetix Application for life insurance and another Kinetix Application for health insurance. Both Kinetix Applications advantageously share a single Data Dictionary, such that data provided by a particular end-user with respect to the life insurance Kinetix Application need not be again provided with respect to the health insurance Kinetix Application (i.e., one Kinetix Application has access to data provided to another Kinetix Application within the same Kinetix System).

A “Kinetix Application” includes a Host Kinetix and, optionally, one or more Hosted Kinetix, which provide support to the Host Kinetix. For example, the life insurance Kinetix Application may include a life insurance Kinetix (the Host Kinetix application program) and a Proactive Help Kinetix (the Hosted Kinetix application program), which provides guidance to the end-user.

Kinetix Applications typically operate in the greater context of a web- or computer-based system. For example, a web site may contain other descriptive content, links, graphics, FAQs, etc., along with one or more Kinetix Applications. The Kinetix Application is typically initiated by the action of the end-user (e.g., the end-user clicks on a button entitled “Get a Quote?”). The applicable Kinetix Application then turns on and proceeds to exchange information with the end-user. Kinetix Applications typically begin by asking broad, general questions. As the end-user responds, the answers to questions may trigger the delivery of more specific questions.

A “Kinetix” comprises a sequence of tics operating within the Kinetix Technology framework and fitting together to cause anticipated but customized outcomes.

A Kinetix can be visualized as a train composed of many different kinds of cars (tics). Kinetix Technology provides the infrastructure—the couplings and train track that join the cars together and on which the cars move. Examples of Kinetix include applications for memberships, loans, insurance, credit, or interactive educational programs. The term “Kinetix” is both singular and plural.

A “tic” is an elementary unit of a Kinetix. A tic is a program construct having a predetermined functionality. The term “tic” implies two concepts. First, it conveys that the tic is contained in a Kinetix, since tic is an audible sylable of Kinetix. Second, it implies the “tick” of a clock. The “tick” of a clock is an analogy to imply that one “tic” relates to another by virtue of its sequence in the Kinetix. Just as trains can start with an engine and end with a caboose, with cattle cars and oil tankers in between, a Kinetix can contain many types of tics, each with specific functionalities.

Tics have predetermined or standardized interactions (coupling) with other tics. The use of standardized code, data exchange rules, and data tables easily allows a Kinetix to include or exclude a particular tic, or change a value within a tic, without requiring extensive reprogramming of how the tics will interact.

Tics arc executed sequentially in streams (a Kinetix). A tic's interaction and capabilities are governed by its position in the Kinetix. Relative to a particular tic, previous tics are considered to be upstream and subsequent tics are considered to be downstream. A given tic can be acted upon by upstream tics and can act upon downstream tics. If data contained in an input tic matches certain predetermined criteria, corresponding downstream tic(s) are rendered active, or visible in the tic stream. When active, these downstream tic(s) run in their turn when all previous tics have run and been validated. For the active downstream tics, pre-filled and/or category data, pulldowns, appearance, or interface attributes may be updated as a consequence of upstream activities. Tics that are not initially active, and are not activated by upstream tics, remain inactive, hence they do not run and are not presented to the end-user.

While conventional program constructs may be processed in a sequence, their functionality and characteristics are independent of the sequence. In contrast, tics are sequential in nature, in that their characteristics (e.g., format, data, visibility) may vary according to their position in the sequence since they may be affected by upstream tics. Tics can be thought to be running when they are presented to the end-user.

In general, a tic is a discrete program construct having a specified function. There are many tic types, each having different functionalities. Examples of tics include server and in-line rules, data, input, hidden data (a tic that is not presented to the end-user), and display (formatting and other sensory data conveyed to the end-user). These tic types arc described in greater detail, below.

A “rule” is a type of tic that performs conditional logic. A rule tests a potentially complex set of upstream conditions involving one or more tics, arrives at a True/False conclusion based on the upstream conditions, and may impact a potentially complex set of downstream conditions involving one or more tics. In general, a rule causes a number of downstream tics, including but not limited to those presented to the end-user, to be re-evaluated. As a consequence, a rule may change the visibility state of certain downstream tics (causing them to become visible or invisible), or may change their value(s). In some cases, rules may also cause the downstream tic sequence to be re-ordered.

Rules may thus select the tics which are to he included in the remainder of the Kinetix. Since every question in the Kinetix may not be applicable to a particular end-user, completion of all the questions is not required. By creating rules that flag certain downstream questions as applicable or inapplicable based on the end-user's previous responses, the Kinetix-developer can ensure that data collection is optimally efficient despite individual differences among end-users, and that each end-user is not inconvenienced by irrelevant questions.

Rules may also be used to change tic values, by customizing or calculating data values based on previous end-user responses, then populating downstream tics. In the above example, if the end-user is eligible for preferred life or health insurance rates, these rates could be provided by the rule, or “pre-filled.” This can be more than simply looking up values in a table. The pre-fill tic values may be calculated based on highly individualized sets of circumstances. For example, proposals could be pre-filled with bid offers based upon complex sets of criteria effected by rule logic.

Downstream tics may be pre-filled with previously entered data. Using rules for pre-fill can dramatically simplify data input by anticipating an end-user's response based on the end-user's previous responses. By using rules, the Kinetix-developer may pre-empt conflict by providing the end-user with only those fields and values that are available as a result of the end-user's previous response(s). The rules allow the interrelationship of data obtained from multiple tics to result in a consistent, non-conflicting answer set.

Importantly, rules allow the Kinetix-developer to create complex logical Kinetix Applications while requiring little knowledge of programming.

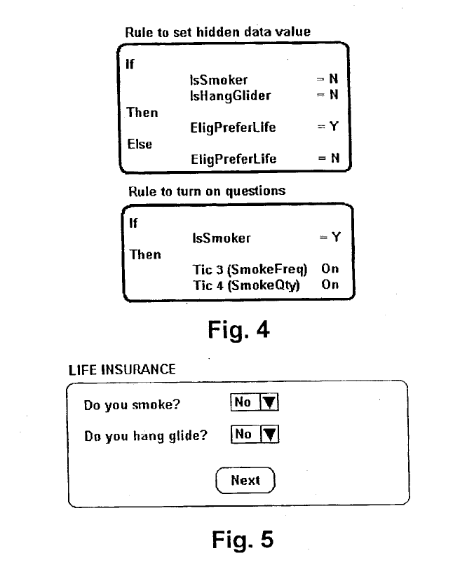

A rule tic affects only certain downstream tics within a particular Kinetix, predetermined by the Kinetix-developer. For example, a rule tic might state that, “if the end-user is a smoker or hang glider, the end-user is not eligible for either preferred life insurance or health insurance rates” (FIG. 4). This example involves five tics: smoker, hang glider, rule tic, preferred life, and preferred health. The smoker and hang glider tics are upstream of the rule tic, while the preferred life and preferred health tics are downstream. The rule tic tests the conditional upstream tic values and impacts the downstream tics as configured by the Kinetix-developer.

The input tic or the data itself need not be visible on the page, but the data does need to exist in some stored form to be acted upon by rules. In-line rules immediately affect the page's display and are thus “client-side rules.” A “server” rule, however, uses one or more data fields stored in the database and enforced by the Data Dictionary. Since this data is not present on the client, server rules cannot immediately affect the page's display. Server rules are used to modify tic display or content on downstream pages.

Rules may be associated with a Kinetix System through the Data Dictionary (e.g., a Validation rule) or with an individual Kinetix (e.g., a Rule tic). Kinetix may be implemented with both types of rules. In client-server type applications, rules may operate on either the client side, the server side, or both.

In a client-server Kinetix Application, the “in-line” rules are client-side. This provides for dynamic customization while minimizing access to the server, thereby conserving bandwidth. An in-line rule is enacted immediately after the preceding input tic is returned from the end-user. A Kinetix with in-line rules customizes itself as it is being used.

In Kinetix requiring more complex logic, logic conditions can be achieved by using multi-condition rule tics or sets of rule tics. In a more complex example, there are two rule tics. The first rule tic evaluates to True and shows a No Fault Option only if the driver is from Massachusetts and has no previous convictions. The second rule tic evaluates to True and shows the No Fault Option only if the driver is from New York and has no previous convictions. Because a driver can be from only one State, only one of these rule tics can be True. These two rule tics are illustrated below:

| Rule 1: | | | |
|---|---|---|---|
| Conditions: | 1) | State: | MA |
| | 2) | Previous Convictions: | 0 |
| All must be True: | | Y | |
| Impacts: | 1) | Show No Fault Option | |
| Rule 2: | | | |
| Conditions: | 1) | State: | NY |
| | 2) | Previous Convictions: | 0 |
| All must be True: | | Y | |
| Impacts: | 1) | Show No Fault Option | |

For example, if the input data includes State=MA and Previous Convictions=1, neither Rule 1 nor Rule 2 evaluates True, and the Show No Fault Option remains hidden. In a second test case, the input data includes State=MA and Previous Convictions=0, so Rule 1 evaluates True, causing the Show No Fault Option to show. Associated with the Show No Fault Option field in the end-user's response, a key identifier is stored to mark Rule 1 as the rule tic that has caused the field to show. Continuing this example, Rule 2 evaluates False, then searches for its key identifier in the list associated with the Show No Fault Option field. Since it isn't there, Rule 2 leaves the field showing.

In a third test case, the end-user goes back and revises the input data to include State=MA and Previous Convictions=1. In this case, Rule 1 now evaluates False. Rule 1 then searches for its key identifier in the list associated with the Show No Fault Option field, finds it, and removes the key identifier. Because no key identifiers are associated with it, the Show No Fault Option field is again hidden.

A “Validation rule” is used to verify that data entered by an end-user conforms to some predetermined criteria (i.e., that the data falls within a subset of logical responses). If the data entered conforms (i.e., is True), the Kinetix proceeds sequentially to the next tic. If the data does not conform to the predetermined criteria (i.e., is False), the Kinetix will repeat the question and present an error message and/or help message. When the end-user's response creates a logical conflict in the answer set, one or more affected tics upstream of the validation rule may be again presented to the end-user.

The “Data Dictionary” is a table (within a database) that maintains the integrity of all data elements in a Kinetix System. All Kinetix in the Kinetix System refer to the Data Dictionary for data elements and the data validations associated with these elements. As an example, one entry in the Data Dictionary might be “Name.” In this case, a Validation rule might determine that a response including non-alphabetic characters is invalid. Another entry in the Data Dictionary might be “Date_of_Birth.” In this case, an associated validation rule might determine that a response prior to Jan. 1, 1880 or after the current date is invalid (particularly if the question refers to the birth date of the end-user).

Validation rules can be used to check the consistency of the end-user's responses by indicating when conflicting answers have been given. For example, if an end-user enters a certain income in one input tic, and later indicates expenditures exceeding that amount, a Validation rule can flag this inconsistency and activate additional detailed question tics, normally hidden from the end-user, to resolve the issue.

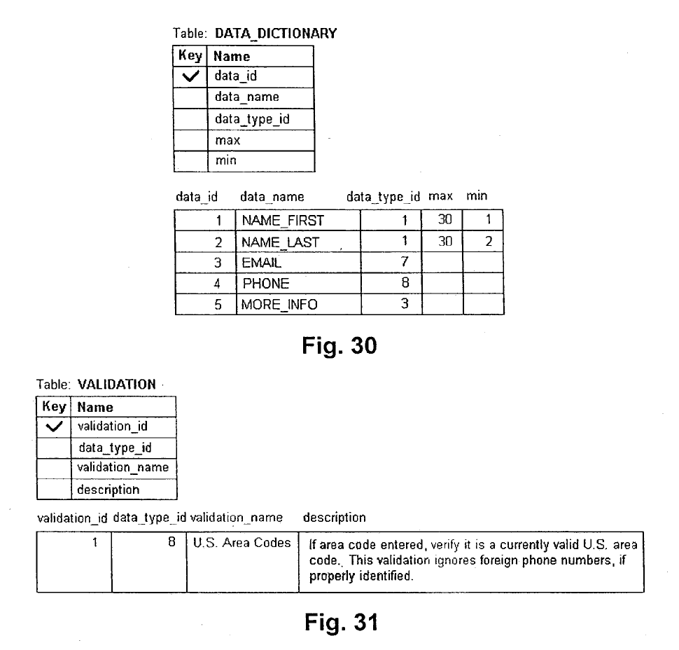

An example of such a Validation rule is shown in FIGS. 29-31. Validation is handled by a number of tables. FIG. 29 specifies that certain data types (e.g., “Text,” “Number,” etc.) have a number of characters within a certain max-min range (the “max-min” box is checked). FIG. 30 defines the max-min range for the particular data type (e.g., “NAME_FIRST” is of a type “Text” having a maximum of 30 characters and a minimum of 1 character). FIG. 31 shows a more specific validation—when the end-user enters an area code, it is matched against a list of valid area codes to determine if the end-user has entered a valid area code.

Although many input tics do not require validation, Kinetix Technology provides the means to do so. Data submitted by the end-user may be validated by validation rules through the Data Dictionary and/or rule tics. Validation may be performed on the server- or client-side, and may consider a single input tic, several input tics on a page, multiple input tics within a Kinetix, and/or multiple input tics and Data Dictionary fields within a Kinetix System.

Though validation is routinely handled by the Data Dictionary via Validation rules, Rule tics may also be used to validate end-user responses. This is useful if a particular validation does not apply to all Kinetix within a Kinetix System.

“Transformation rules” may also be used in a Kinetix System. If so, they are part of the Data Dictionary, since the they relate to the data, independent of the Kinetix. Transformation categories are stored with the data to simplify the operation of business (or logic) rules. For example, if the Data Dictionary stores the end-user's age as a range, e.g., “45-49,” and the end-user has entered “46,” a transformation rule in the Data Dictionary can receive the end-user's input and classify it appropriately. In most cases, it is good practice to save the more granular data, e.g., the end-user's age of “46,” in addition to the transformation category, e.g., “45-49.”

To collect information from the end-user, Kinetix Technology uses standard interface constructs, such as textboxes, pulldowns, listboxes, checkboxes, radio buttons, and so forth. Each such construct is created as an “input tic.” An input tic asks for data from an end-user and, as such, is considered a “data tic.” All input tics are data tics. However, not all data tics are input tics, since some data tics simply provide data to the end-user, without requesting input from the end-user.

An input tic includes an end-user interface and a data clement. The end-user interface typically includes a question to be answered, formatting information and, in some cases, optional help and/or multimedia assistance related to the requested data. Data received from the end-user may be subjected to various validation criteria to ensure proper data entry.

Typically, one data element is associated with each input tic. However, it is possible to associate multiple data elements with a single input tic. For example; a “contact” tic can include the end-user's full name and address in a particular format. A transformation rule can then parse the data to the various affected database fields.

The data element of an input tic has a number of possible attributes. Data obtained from the end-user is generally stored in the system database and controlled globally in the Data Dictionary. Global data to be stored can also be pre-filled or categorized. Pre-filled data may be simple (the same value for every end-user) or dynamic (altered or calculated based upon upstream tics). Pre-fill data can come from third-party sources, previous sessions stored in the database, inference or calculation on previous data, logon, cookies, other Kinetix within the same Kinetix system, or prior sections of the same Kinetix.

The programmer may create “display tics” to provide a more interesting interface for the end-user. Display tics can include text (e.g, plain text, rich formatted text), company logos, illustrations, photographs, banners to separate sections, borders, video clips, and the background over which all tics are placed. Display tics are not limited to the visual presentation of the questionnaire, but can be audio (e.g., a sound clip), or even olfactory, kinesthetic, or tactile, as well. For example, a display tic can be used in conjunction with a rule tic to sound a tone if the end-user enters an invalid response.

A Kinetix Application can also include “hidden tics” that are not presented to the end-user. Hidden tics include, for example, hidden data tics and rule tics.

A “page break” tic is used as a logical break between one set of tics (which form the page) and another set of tics. A page break stops the further presentation of tics until the end-user takes an action, such as clicking a “Next” button in a visual Kinetix. In this case, the affected page consists of all tics, visible and invisible, forming the page. The page break causes the server to build and present the next page to the end-user. The contents of this new page may be controlled by the logic enacted by the previous tics upstream to the new page, as described above. Pages may also be refreshed, e.g., to display impacted tics, without necessarily accessing the server, by using an in-line rule tic, as described above.

A Kinetic System may contain multiple Kinetix Applications operating concurrently. For example, both a life insurance Kinetix Application and a health insurance Kinetix Application may ask the same question, such as whether or not the end-user hang glides. In the life insurance Kinetix Application, the question may read “Do you hang glide?” while for health insurance Kinetix Application, the question may read “Have you ever gone hang gliding.?” Supposing the two input tics to use the same data element, such as HANG_GLIDING, certain properties exist. In a Kinetix System, multiple Kinetix Applications may reference a single Data Dictionary. A Kinetix operating within the Kinetix System need only ask for data input on a single data element once, though the Kinetix can display the results many times. Data validations of individual input tics are maintained by the Data Dictionary of the Kinetix System, not by the individual Kinetix. Data presentation, however, including the phrasing of questions, graphics, and multimedia displays, are maintained by the individual Kinetix.

While the following examples relate generally to intelligent questionnaires that determine which questions to ask, their order, etc., other applications exist for Kinetix Technology. As previously noted, a tic can provide help in answering an associated question. A Kinetix can be used to provide very detailed help based upon the end-user's previous responses, thereby providing user-sensitive help. The end-user help Kinetix can be programmed to start automatically for known high confusion questions, when the end-user enters an invalid response, or when the end-user takes an especially long time in responding to a given question, possibly indicating end-user confusion.

Kinetix can also be used to provide customized interactive assistance. This can include tips or progress indicators. A dynamic set of“Breadcrumbs” allowing the end-user to easily navigate back to previous sections or web pages can readily be provided. Context and/or user-specific advertising and/or links can be provided through rule tics to allow rapid customization of an Internet web page. If a Kinetix Application stores and retrieves end-user data each time the end-user visits the Internet site or Kinetix Application, the sensitivity of the interaction can increase with repeated use as the Kinetix Application better “knows” the end-user.

It is possible to have multiple Kinetix running concurrently within a Kinetix Application. These Kinetix are different “windows” on the same underlying data, but each serve a particular purpose. Thus, one “pane” might be processing an “advice” Kinetix, another might process a “contest” Kinetix, another might process an “observation” Kinetix, and so on.

When multiple Kinetix are running concurrently, one will generally be the “Host” Kinetix, meaning that it controls modification of the database through the Data Dictionary. Other concurrent Kinetix will generally be “Hosted,” meaning that they provide support to the Host Kinetix to which they are linked.

For example, a “Proactive Help Kinetix” can be designed to provide contextual assistance to the end-user based upon the data entered thus far by the end-user. This Proactive Help Kinetix is “hosted” by the Host Kinetix. The Proactive Help Kinetix constantly checks end-user entered data to determine if any of its in-line rules evaluate as True. Once an in-line rule within the Proactive Help Kinetix becomes True, the Proactive Help Kinetix is initiated and can provide guidance. As an example, the Proactive Help Kinetix can suggest an appropriate answer if the Data Dictionary indicates that the end-user entered data is not valid, and/or explain why the answer is not acceptable. While the Proactive Help Kinetix can suggest an appropriate answer, only the Host Kinetix can actually update the stored data, thereby ensuring the integrity of the database.

Other Kinetix could be loosely associated with a Host Kinetix, or not associated at all. For example, a loosely associated Kinetix could provide advertising hyperlinks based upon the general subject of the Host Kinetix.

A Kinetix that is not associated with the Host Kinetix could perform another function using similar data. For example, if both an auto insurance Kinetix Application and a health insurance Kinetix Application within a Kinetix System are open, the end-user can go from one Kinetix Application to the other without reentering data or creating logical conflicts, because the data integrity of both is enforced by the common Data Dictionary. Of course, both such Kinetix Applications can also host multiple hosted Kinetix, for help, hyperlinks, animations, video clips, examples, etc. Further, two completely independent Kinetix, within separate Kinetix Systems, may function concurrently through conventional multitasking.

The general example described for the present invention is that of a service which provides quotes for various types of insurance from multiple insurance providers. Other uses for Kinetix Technology are interactive training programs, applications for jobs, services, benefits, and memberships, or any other activity involving the interactive flow of information. It is also conceivable that a Kinetix System could involve the interactive flow of kinesthetic information, for physical training such as physical rehabilitation, golfing, or virtual aircraft/spacecraft piloting.

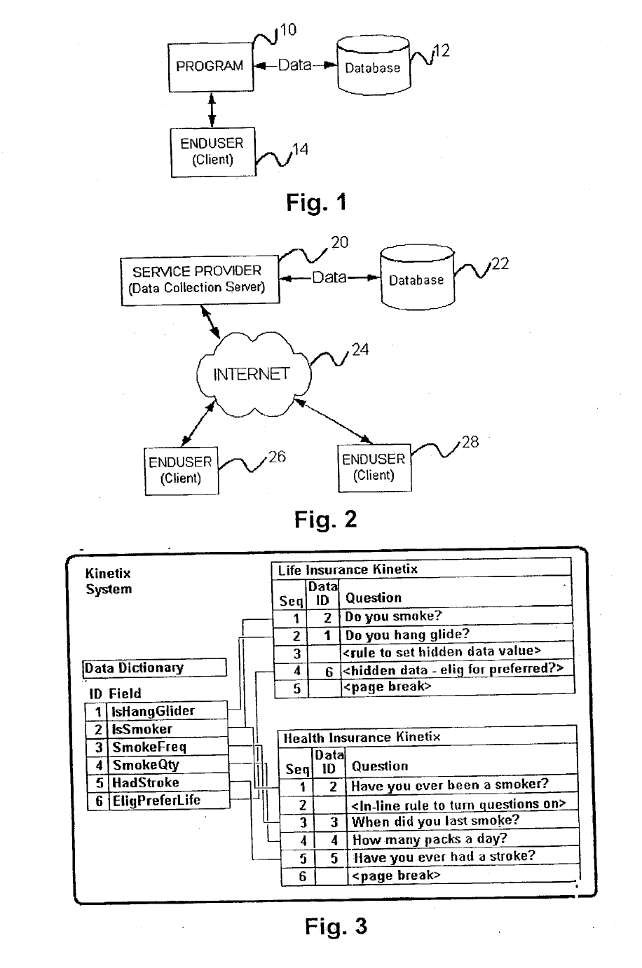

Kinetix Applications may be used over the Internet, a local area network, on an individual computer, or in other configurations, such as in an Interactive Voice Response (IVR) system. A typical setting for implementation of the present invention, as shown at FIG. 1, would be a computer employing Kinetix Technology. A program 10 connects to a database 12, and serves one or more end-users 14.

The end-user may access a Kinetix on the end-user's computer (stand alone system) or on a server through a network (client-server system). FIG. 2 shows an Internet setting for implementation of the present invention. A service provider operates a server 20 that is connected to a database 22 and to the Internet 24. End-users 26 and 28 exchange information with server 20 through the Internet 24, using a browser.

FIG. 3 illustrates how Kinetix Technology works. In this example, there are two Kinetix Applications: one for life insurance and one for health insurance. Each Kinetix Application contains a single Host Kinetix (the Life Insurance Kinetix and the Health Insurance Kinetix). Note that the first tic (Sequence 1) in both Kinetix refers to the same data element “IsSmoker” in the Data Dictionary. However, the actual question asked may vary (e.g., “Do you smoke?” in the life insurance Kinetix and “Have you ever been a smoker?” in the health insurance Kinetix). In Kinetix Applications, data is generally managed centrally by the Data Dictionary, while other items, such as question text formatting and sequence, are generally managed locally (in the individual Kinetix). This provides maximum flexibility for content while maintaining data integrity.

When an end-user requests a life insurance quote, the life insurance Kinetix is executed. The Kinetix (FIG. 3) processes a sequence or set of tics (tics 1 thru 5). Upon reaching a page break tic (tic 5), it draws the entire page and sends it to the end-user's screen. The page is displayed to the end-user (FIG. 5), who then answers the two questions. An affirmative answer to either question sets a hidden data value (FIG. 3). When the end-user responds to a query, the data is referred to the Data Dictionary, which validates the data according to pre-programmed criteria. If the data is unacceptable (invalid), the program redraws the page with an error message and/or contextual help. If the data is acceptable (valid), control passes to the next tic in the Kinetix. Not all questions require validation, such as those presented in FIG. 5.

Rules are used to evaluate end-user responses to upstream input tics and, if called for, modify dependent downstream tics referred to as “impact tics.” FIG. 4 depicts two typical rules and their effects. The first rule, within a life insurance Kinetix, determines whether the end-user is eligible for a preferred premium rate, and sets a Yes/No value after evaluating the end-user's responses to two upstream questions. The second rule, for a health insurance Kinetix, presents additional questions to the end-user if the end-user indicates that he is a smoker.

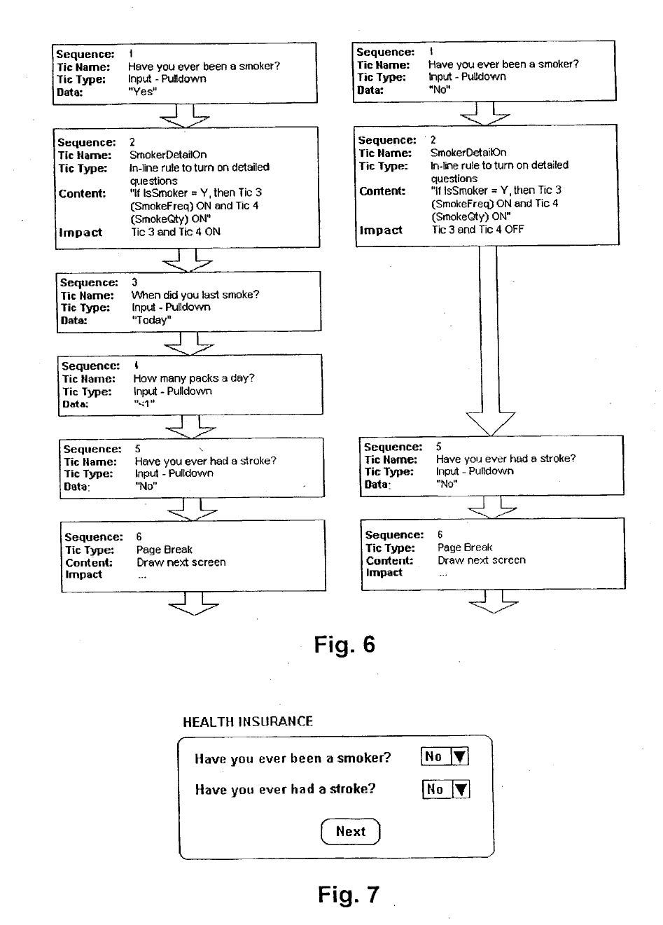

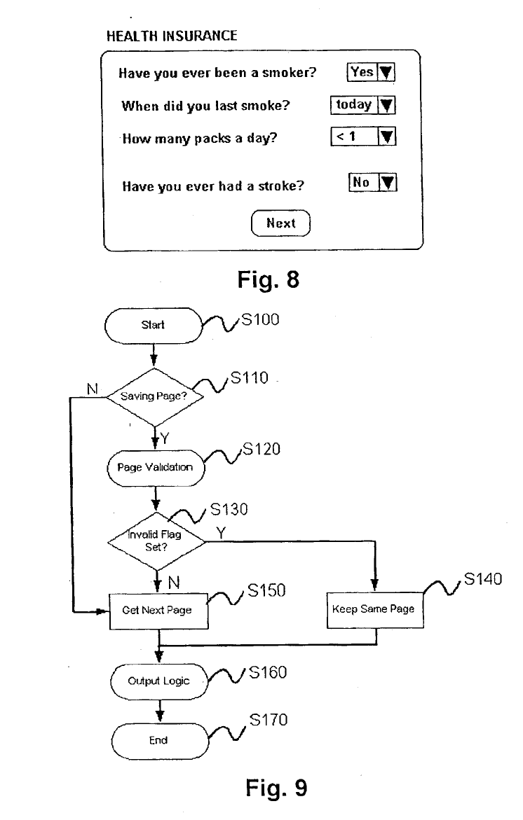

FIG. 6 details the function of the second rule shown in FIG. 4. Detailed questions relating to smoking habits are not shown until and unless the end-user answers affirmatively to the first tic (IsSmoker). The column on the left indicates an in-line rule being activated by the end-user's answer of Yes to being a smoker, while the column on the right shows tics 3 and 4 remaining inactive and hidden given an end-user's answer of No to being a smoker. Like most rules, this in-line rule is invisible to the end-user. However, the results of in-line rule evaluations may be visible. FIG. 7 depicts the end-user's initial screen, which does not change where the end-user answers No to being a smoker. FIG. 8 depicts the end-user's screen in the instance where the end-user answers Yes to having been a smoker. The in-line rule causes additional questions to appear in context, i.e., the tics corresponding to Data IDs 3 and 4 of FIG. 3 are displayed to elicit more detailed information concerning the end-user's smoking habits. Alternatively, these questions can appear on a separate page, by using a page break to refresh the end-user's screen with the impact tics IDs 3 and 4 of the Health Insurance Kinetix shown in FIG. 3.

The example shown in FIGS. 3 through 8 illustrates several principles of Kinetix: rules can impact data, text, and formatting, or the display/hide attributes of downstream tics. For example, the hidden “Eligible for Preferred Rates” field is downstream of the life insurance rule in FIG. 4. Rules act upon upstream input tic information. Downstream tics may be dependent on the values of upstream input tics. “Have you ever been a smoker?” in the health insurance Kinetix, is upstream of the rule that turns on dependent detailed questions about smoking habits. The order of tics within a Kinetix is pre-set by the designer. This does not, however, prevent end-users from navigating upstream or downstream with hyperlinks or controls. Generally, displays without visible input tics are skipped by default, though this can be overridden.

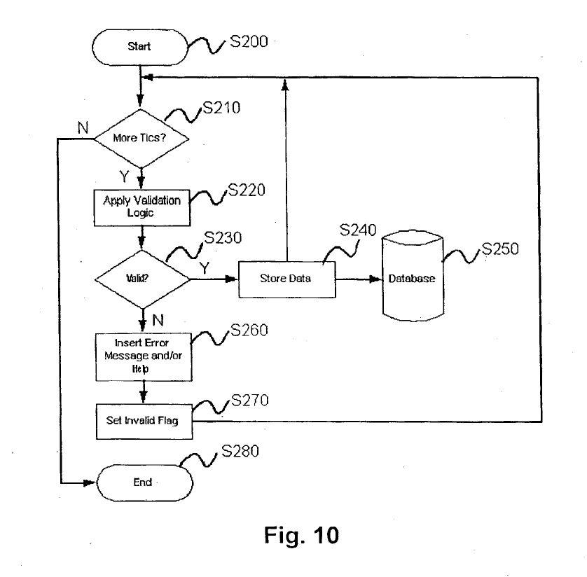

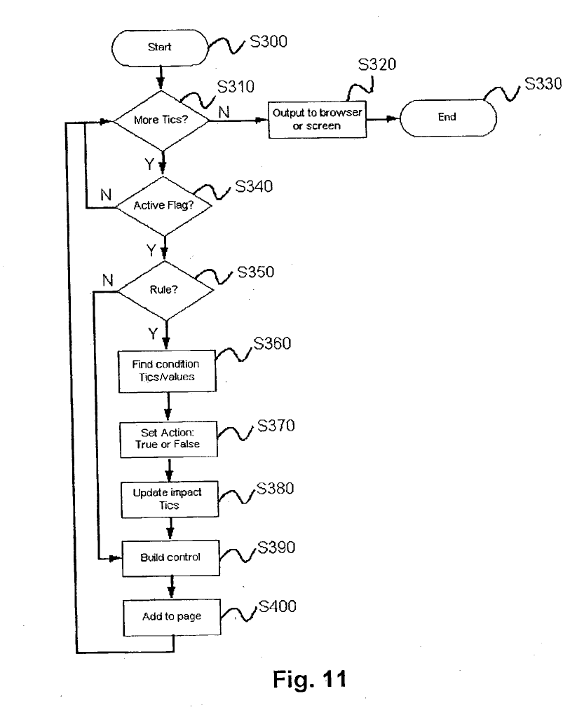

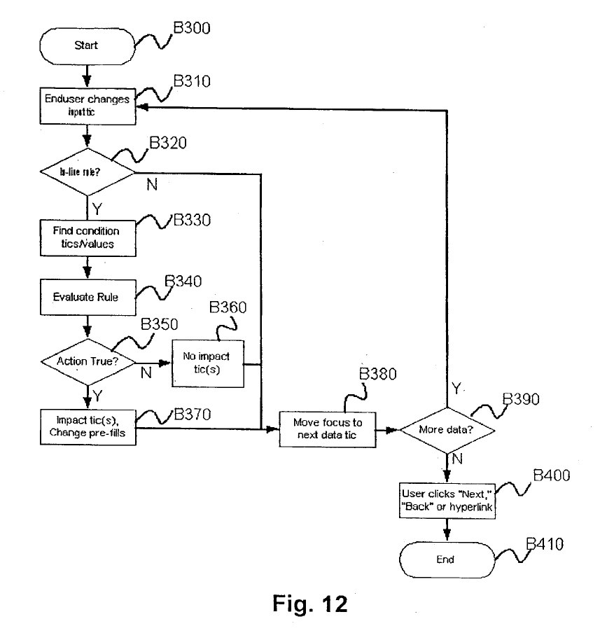

The structure and operation of Kinetix Technology may be further described by reference to FIGS. 9 through 12. FIG. 9 illustrates the server side of a Kinetix Application as it applies to Internet web pages, FIG. 10 depicts a more detailed page validation logic flow (on the server side) and FIG. 11 shows output logic. FIG. 12 illustrates the browser/client side of a Kinetix Application. Note that the Kinetix Application could also be created with validation taking place on the client side, one input tic at a time.

As shown in FIG. 9, the Kinetix Application starts in step S100. In step S110, the Kinetix Application checks whether or not a previous page has been returned from the end-user containing responses to be saved in the database. If no previous page was returned from the end-user at step S110:N, as is always the case at the program's start, the Kinetix Application pulls the data elements required for the next page at step S150, then sends it to the output logic at step S160, as detailed in FIG. 11.

If a previous page has been returned from the end-user at step S110:Y, the previous page is subjected to its associated validation logic in step S120, as detailed in FIG. 10. Upon the page's return from the validation loop, it is checked for a flag indicating that the page contains data that does not satisfy the validation criteria at step S130. If so, at step S130:Y, the system logic can keep the same page at step S140, then send it to the output logic at step S160.

If the validation rules did not set an invalid flag for the most recent page processed at step S130:N, the program retrieves the set of tics forming the next page from the database at step S150, then sends it to the output logic at step S160. The Kinetix Application ends at step S170.

FIG. 10 depicts a detail of the page validation logic. Validation proceeds sequentially through all input tics contained in a page. Validation starts at step S200. The first validation stage S210 checks whether or not there arc any more input tics within the subject page. If the answer is no at step S210:N, validation is complete for that page at step S280.

If there is another input tic to validate at step S210:Y, any pre-programmed validation logic associated with that tic is applied at step S220. If the data is determined to satisfy the criteria for the validation logic at step S230:Y it is stored at step S240 to the database at step S250. If the data is determined to be invalid, it is flagged as such at step S270, and if programmed to do so, the Kinetix Application may insert a contextual error message and/or help content at step S260. Then the logic loop returns to look for the next input tic at step S210. When all input tics for the page have been validated, and none remain, validation for that page is complete at step S280.

If the page contains any invalid flags at step S130:Y in FIG. 9 (which were set at step S270 in FIG. 10), the system forwards the same page at step S140 to the output logic at step S160.

FIG. 11 outlines the output logic. The Kinetix Application starts in step S300 with the arrival of a page. Output logic proceeds sequentially through all tics contained in the page. The first stage at step S310 checks whether or not there are any more tics within the subject page. If the answer is no at step S310:N, the page is complete and is output to the browser or screen at step S320. The output logic then ends at step S330.

If there is another tic to evaluate at step S310:Y, the logic checks for the active flag at step S340. If there is no active flag, the tic remains inactive and hidden to the end-user, no further logic is required, and the system seeks out the next tic at step S310. If there is an active flag at step S340:Y, the system looks for an associated rule or rules at step S350. If there is no rule associated with that tic at step S350:N, that tic is built as a control at step S390 and added to the page at step S400.

If a rule is associated with that tic at step S350:Y, the system retrieves the upstream input tic value(s) at step S360 required by the rule for conditional logic. The rule is determined to be true or false at step S370, and all affected downstream (impact) tics are updated at step S380. The tic is built as a control at step S390 and added to the page at step S400.

FIG. 12 illustrates the browser/client side logic of a Kinetix Application. This illustrates how in-line rules can affect downstream elements (hide or make available to the end-user, pre-fill, etc.) without necessarily accessing the server (refer also to the example presented in FIGS. 6 and 8). The Kinetix Application starts at step B300 with the arrival of a page from the server. The end-user provides data to an input tic at step B310; e.g., “Have you ever been a smoker?” At step B320, a function within the Kinetix Application is triggered by the end-user's response, and determines if the answer is associated with an in-line rule. If not, the function moves the focus to the next input tic at step B380. A function at step B390 determines if there is more data. If so, at step B390:Y, the focus returns to the end-user's response to the next tic, looping back to B310, e.g. “Do you hang glide?” (FIG. 5).

If the end-user answered Yes to being a smoker at step B310, the function at B320 finds the related in-line rule and retrieves any required conditional data in step B330. The in-line rule then evaluates the response at step B340. If the rule evaluates as True at step B350:Y, then the rule modifies any impact tics dependent on that rule being true in step B370.

For example, if the subject input tic text is “Have you ever been a smoker?” (FIG. 3) and the end-user selected Yes at step B350:Y, the associated in-line rule (FIG. 3) is determined to be true, and two hidden input tics (“When did you last smoke?” and “How many packs a day?”) are made visible in step B370. If the end-user's response is No, the rule is determined to be False at step B350:N, there is no impact on downstream tics and the dependent input tics (“When did you last smoke?” and “How many packs a day?”) remain hidden at step S360.

When the function at step B390 determines that there is no more data due, it awaits the end-user's next action, such as clicking the “Next” button, in step B400. The Kinetix Application ends at step B460.

The process from step B300 to step B410 is repeated as long as the Kinetix Application server continues to transfer web pages (formed by tic sets) to the browser.

In practice, it may be preferable to move validation logic to the client or browser side to better utilize resources. There, both in-line rules and validation logic operate on tics individually and in sequence, providing immediate response in the form of error messages, contextual help, and effect on downstream elements.

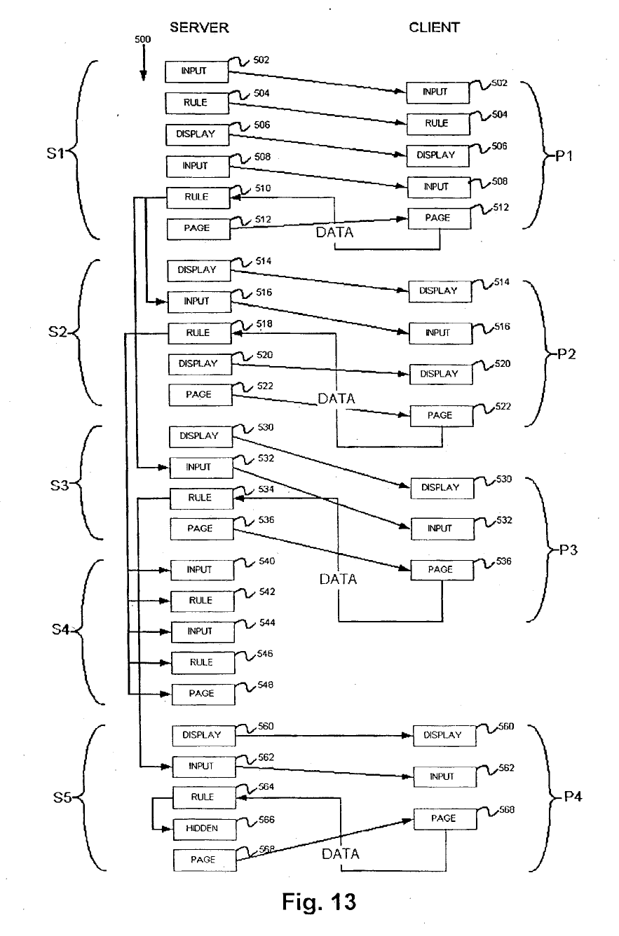

A still further illustration of the present invention is shown in FIG. 13. A Kinetix 500 is present at the server and comprises the sequential tics from 502 through 568 in tic sets S1, S2, S3, S4, and S5. In this example, all rules are server rules (server-side) except in-line rule 504 (client-side).

Set S1 of Kinetix 500 has in sequence an input tic 502, in-line rule tic 504, display tic 506, input tic 508, and a rule tic 510 followed by a page break tic 512.

Set S2 has a display tic 514, an input tic 516, a rule tic 518, and display tic 520 followed by a page break tic 522.

Set S3 has a display tic 530, an input tic 532 followed by rule tic 534, and page break tic 536.

Set S4 comprises the sequence of an input tic 540, a rule tic 542, an input tic 544 followed by rule tic 546, and a page break tic 548.

Set S5 has in sequence a display tic 560, an input tic 562 followed by rule tic 564, hidden input tic 566, and page break tic 568.

Further referring to FIG. 13 in operation, when an end-user makes an inquiry through the client to activate the Kinetix 500, the server evaluates the tics in set S1 to build page P1 on the client. Page P1 includes input tics 502 and 508, in-line (client-side) rule 504, display tic 506, and page break tic 512. The end-user answers the question required by input tic 502, and in-line rule 504 evaluates the user-supplied data. If rule 504 proves True, it activates hitherto hidden impact tics 506 and 508. At the end of the page, the end-user activates page break tic 512, for example, by clicking on a “NEWT” icon. When this step is performed, the data that has been collected at the client is transmitted back to the server that includes server rule tic 510 that uses this data. All of the data received is stored in the Data Dictionary in association with the database file for the particular end-user.

Rule tic 510 receives the information provided by the end-user (input tic 502 and/or 508), and evaluates it. If the rule evaluates True, the Kinetix 500 will modify impact input tic 532 in set S3. Input tic 532 could, for example, offer ten different amounts of insurance coverage, but the answer data submitted to rule tic 510 could eliminate a group of these coverages, therefore modifying the information content of tic 532 when it is ultimately utilized and sent to the client.

In a similar manner, rule tic 510 also uses information collected at the client for modification of input tic 516. Input tic 516 could, for example, offer a choice of insurance carriers, but a particular carrier may be eliminated by rule tic 510, due to input tics 502 and 508, thus the content of the input tic 516 is changed.

After the actions required by rule tics 504 and 510 have been implemented, the set S2 is processed and the data input, display, and page break tics are transmitted to form page P2 at the client. The end-user responds to the information request by tic 516. When the end-user clicks “Next” at page break tic 522, the response to page P2 is complete and data is transmitted back to the server. The collected data is stored, and rule 518 evaluates it for dependency effects.

For example, data returned in tic 516 might concern end-user traffic violations. If the end-user answered No, then no further information inquiries need to be made in this regard. Since the input tics in set S4 are directed to acquiring specific information about traffic violations, and the end-user indicated in tic 516 that he had no traffic violations, rule 518 determines that none of the input tics related to set S4 should be implemented, and these remain deselected (hidden from the end-user).

Set S3 is then transmitted to the client to form page P3. This comprises display tic 530, input tic 532, and page break tic 536. When the end-user activates page break tic 536, the collected data is transmitted back to the server for storage and evaluation by rule tic 534. This rule then modifies input tic 562 within set S5. For example, this could be a change in the information that is supplied to the end-user by input tic 562.

After processing the data received from page P3, the server identifies that all of the tics within set S4 have been deselected and therefore these are skipped, and a transition is made directly to set S5. Note that due to the universal interface design of the tics within the Kinetix 500, no special programming was required to delete the tics of set S4. The Kinetix 500 creates a page from set S5 (display tic 560, input tic 562, and page break tic 568) and transmits it to the client as page P4. As with the above pages, when the end-user enters information into tic 562 and activates page break tic 568, the data thus collected is returned for storage at the server and provided to rule tic 564. In the present example, rule tic 564 updates the contents of hidden data storage tic 566. This represents the collection of all information needed for the particular inquiry posed by the end-user and processing of this Kinetix 500 is complete.

With respect to FIG. 13, the Kinetix represented by column 500 is dynamically modified as information is collected to customize downstream tics for that specific end-user. This customization optimizes the data collection process for greater end-user satisfaction. Further, with respect to FIG. 13, if the Kinetix 500 is implemented in a World Wide Web setting, the pages created by Sets S1, S2, S3 and S5 are HTML pages. Of course, other types of output may be created depending on the environment in which the Kinetix is implemented. For example, a Kinetix operating an IVR front end would output verbal messages. A kinesthetic application might output resistance to a force feedback mechanism.

To better understand the specifics of Kinetix Technology, the following section will describe how various types of tics can be designed and assembled to form a Kinetix related to auto insurance.

The basic structure of Kinetix field positioning, in the following example, is to have a 12-column HTML table, and insert controls in a left-to-right, top-to-bottom fashion. It should be noted that while the following example uses 12 equal-width columns, Kinetix technology is not limited to 12 columns, or column format at all, as the underlying HTML rules provide for (x,y) positioning of elements. Other methods of positioning the elements may be employed depending on the page format (HTML or otherwise) and some Kinetix (e.g., IVR or kinesthetic applications) may not require field positioning at all

An auto insurance Kinetix can be built as follows:

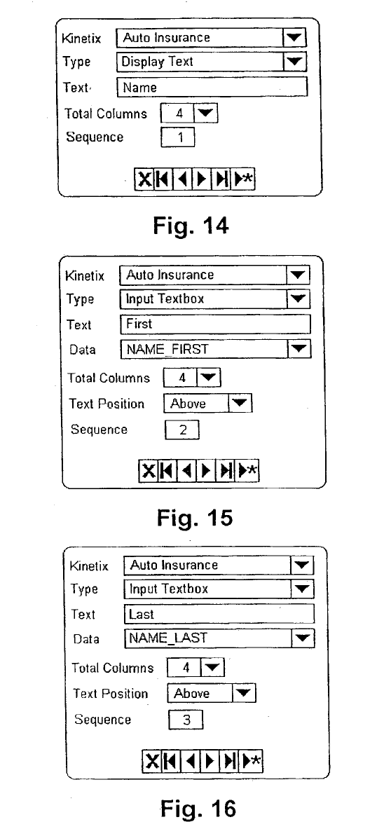

FIG. 14 illustrates the first tic design window. The first tic is a “Display Text” tic that stores no permanent data, it merely displays text to the screen. The text this tic displays is “Name.” In the 12-column table, it occupies only 4 columns, i.e., one third of the first row. It is the first tic in this sequence. The icons at the bottom of the tic design window are for basic design functions. The icons, from left to right, represent “Delete,” “Move First,” “Move Previous,” “Move Next,” “Move Toast,” and “insert.” These controls allow the designer to move within the Kinetix currently being designed to ensure proper ordering of the tics, etc.

The second tic in the sequence is an “Input Textbox” tic. Because an input textbox tic stores data, a data field appears on the design screen as seen in FIG. 15. From the Data Dictionary, the data field “NAME_FIRST” is selected. The Data Dictionary will perform all validations necessary for this field, including how many characters are acceptable, whether or not data should be allowed in mixed case vs. upper case, etc. Even though this tic stores data, it also includes a text label. This text label is “First,” and it has the text position “Above,” meaning it will appear above the textbox. Like the Display Text tic, it is 4 columns wide, and due to their sequence, this Input Textbox tic occupies the second third of the first row.

The third tic in the sequence is quite similar to the second and its design screen is illustrated in FIG. 16. This tic is an Input Textbox tic that will use the data field “NAME_LAST” for validation by the Data Dictionary. This tic is 4 columns wide and will occupy the last third of the first line.

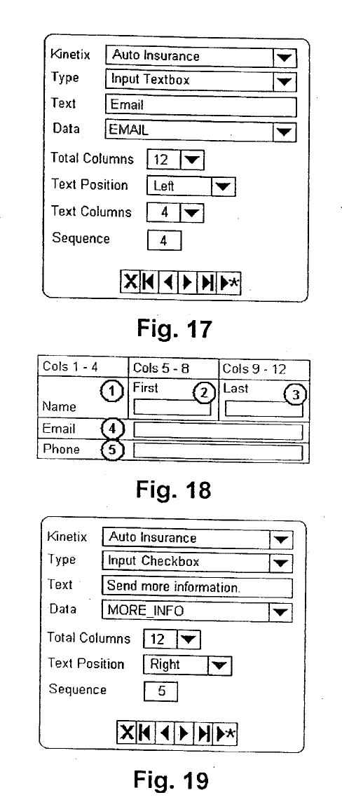

Because 12 columns have been included so far, the first row is complete. Therefore, the fourth tic, an Input Textbox tic whose design screen is shown in FIG. 17 begins the second row. This Input Textbox tic is associated with the data field EMAIL, and includes a new feature not shown in the previous Input Textbox tics. By selecting the text position to be “Left,” the designer must select the number of columns the text “Email” will occupy. In this example, the Kinetix-developer has selected 4 columns. As the total number of available columns for this example is 12 and the text label “Email” will occupy the first 4 columns, the space for the actual textbox is thus the remaining 8 columns of the second row.

A “Phone Tic,” is added next. In this case, the data type for validation by the Data Dictionary is PHONE (see FIG. 29).

From a Kinetix design perspective, the first five tics in this Kinetix described above will appear as shown in FIG. 18. The five tics in sequence from left to right, top to bottom, are identified by the boldfaced circles. Each tic is positioned to the right of the previous tic until a full line of 12 columns is defined. The next tic will then be wrapped around to begin the next line. If the tic has an associated label, the label will appear in the position selected by the Kinetix-developer. For example, the label may appear above the input (as shown in sequences 2 and 3), per the selection shown in FIGS. 15 and 16. Other possible label positions are below, to the right, or not at all. When a label is to appear to the left or right of the input textbox, the number of columns devoted to the label must be specified. A value of zero columns is possible, forcing the label and input text to share the same columns. This can be used for items such as putting a dollar sign symbol ($) immediately in front of the input.

Continuing this example, the Kinetix-developer now decides to add an “Input Checkbox” tic: “Send more information” after Email and before Phone (FIG. 19). This design screen incorporates one column for the checkbox, and the remaining columns for a label. By numbering this tic as sequence 5, the remaining tics (in this case, just the Phone tic) are automatically incremented by the Kinetix development system to allow for easy insertion of tics and reordering of tics within a Kinetix. Data representing whether the checkbox is checked or not is stored in the field MORE_INFO.

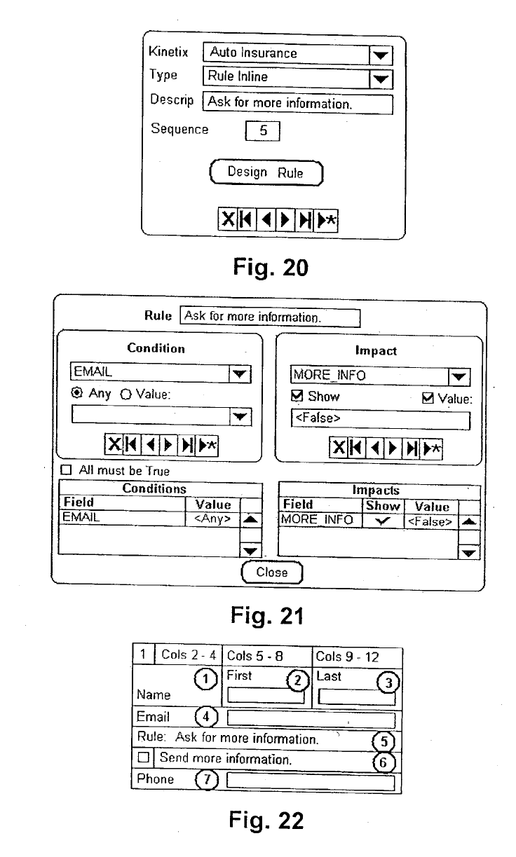

As the “Send more information” tic need only be displayed when an Email address has been entered, in this example the Kinetix-developer decides to add an in-line rule tic. The in-line rule tic provides the logic that determines whether or not the “Send more information” tic will be displayed. Because the in-line rule tic will not be displayed, this type of tic does not have column dimensions or positioning (FIG. 20). Note that by specifying this in-line rule tic as sequence 5, the “Send more information” tic is forced to become sequence 6, etc. By specifying an in-line rule tic, a “Design Rule” button appears as shown in FIG. 20. By clicking on the Design Rule button, a Rule Design screen appears as shown in FIG. 21.

The design of a rule tic involves selecting at least one condition and at least one impact Rules are essentially “if-then” statements, e.g., if a condition is satisfied, then an impact occurs, as shown in FIG. 4. Conditions are logical evaluations of one or more data tics, e.g., “If IsSmoker=N and IsHangGlider=N.” Impacts are one or more tics and the effect on those tics when the rule evaluates as “True,” e.g., “then EligPreferLife=Y.” Conditions sequentially precede the rule tic, and impacts sequentially follow the rule tic within the Kinetix sequence.

In the present example shown in FIG. 21, there is only one condition and only one impact. The condition is the Email input tic and the corresponding value is indicated as <Any>. Thus, as long as the data EMAIL is not null, the rule will evaluate to True.

This example is a single condition rule. However, in a multiple condition rule, the default is to set the rule True if any of the rule's conditions are True. Otherwise, the designer may select the checkbox “All must be True.”

The “Send more information” tic is the impact input tic in the present example; it is set to “Show” and its checkbox value is set to <False> if the rule is True In the case of more than one impact tic, each individual impact tic can be set to Show or not, and its value may be set, modified, or cleared.

The seven tics described above, including the in-line rule tic, appear as shown in FIG. 22. Note that although the in-line rule tic occupies sequence 5, like all rules, has no physical representation on the page.

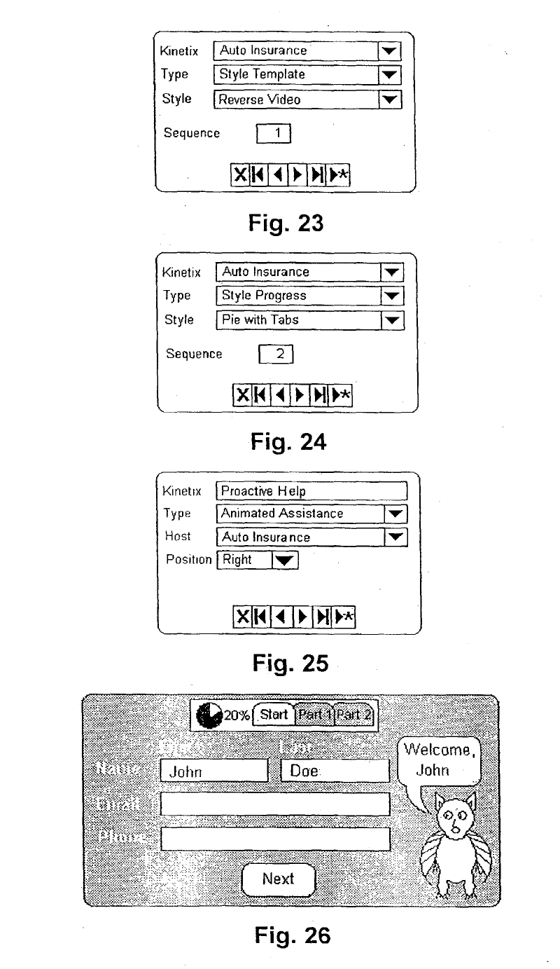

Once the basic tic sequence has been determined, the presentation of the Kinetix can be designed. The presentation of the Kinetix can be altered through the use of various “Style Template” tics. These various style template tics can be applied to the entire Kinetix, or for individual pages or screens, depending upon their location within the overall sequence of tics. A sample style template tic design screen is shown in FIG. 23. This style template tic specifies the Kinetix is to use “Reverse Video,” the name assigned to a style in which text appears white, and the background dark, to add emphasis for example. Note that by designating the style template tic as sequence 1, this tic is then applied to the entire Kinetix. By placing this style template later in the sequence, only that portion of the Kinetix following it would be in reverse video.

Kinetix Technology provides for many types of “section formatting” tics, including “page,” “stage,” “instance,” “sub-instance,” and other hierarchal constructs. “Page'and Stage” tic types manage page breaks and stages (Kinetix sub-sections, which may contain multiple pages), and their association with the breadcrumbs.

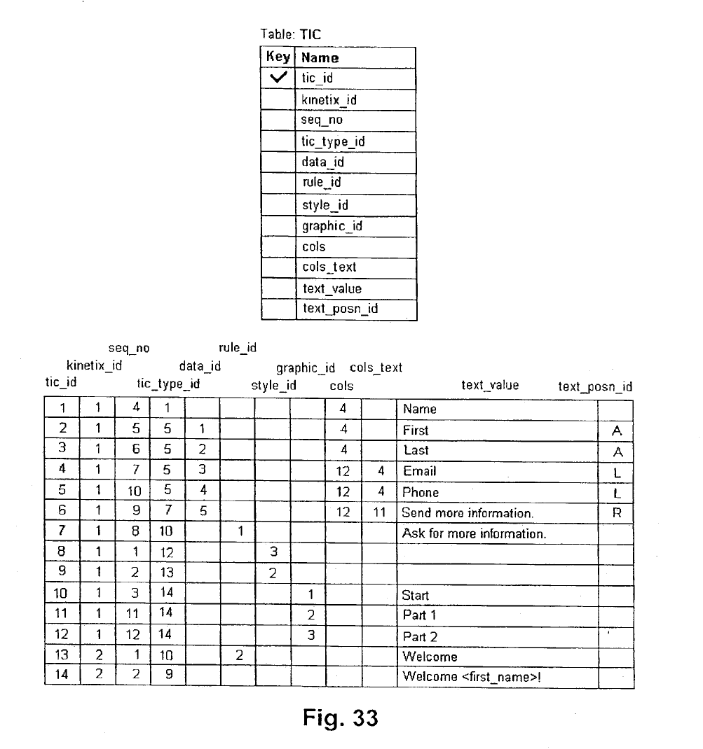

More complex Kinetix Systems may require a more complex hierarchical structure to contain many logical branches. Stage type tics create major sections, indicated by tabs (e.g., “Start,” “Part 1, ” and “Part 2”) as shown in FIGS. 26 and 33. These tabs allow the end-user to easily navigate to different parts of the Kinetix. Within each stage, there may be other hierarchical tic types, such as substage, instance, or page. Drilling down further, subinstances may be required, and so on. For example, an Automobile Insurance Kinetix may consist of three stages (referring to FIG. 33): “Start,” which defines the process, provides hyperlinks to additional information, etc.; “Part 1, ” which contains all the tics related to the driver, and “Part 2, ” which contains all the tics related to the vehicle. Within Part 1, we may have a first substage tic “About the Driver,” followed by a number of tics related to driver information (name, address, age, etc.) and a second substage tic “Convictions,” detailing the driver's record. Each of these substages may contain multiple pages. For multiple drivers, we may use “Instance” tics, where the driver information is retained under its instance hierarchy. Likewise, multiple convictions call for multiple instances. In some cases, subinstances can be used to further extend the hierarchy into greater levels of detail.

A Kinetix may have a Style Progress tic to indicate progress, followed by Stage, Stage Sub 1, Stage Sub 2, Page, and/or Page OnRequest tics for updating the end-user's progress. The Stage type tics create tabs, while the Stage sub type tics create expandable tree-like folders within a section that permit hyperlinks back to more specific parts of a section.

A Kinetix-developer may implement indicators that provide end-users with an idea of how much of the Kinetix they have finished and how much remains. In these cases, progress indicators and breadcrumbs can be implemented as a unit, and serve as the primary page break mechanism. The “Next” button (and “Back” button on subsequent pages) may be generated through this mechanism. A Style Progress tic and one or more stage tics are necessary to support progress indication.

“Function” tics may also be used to perform specific programmed functions. For example, the Next and Back button functionality may also be implemented as function tics. Clicking on the Back button calls a function that re-opens the previous page; clicking the Next button activates a function that sends the next page to the end-user's screen. Other examples of function tics include buttons that call forth special calculators (home value estimator, car trade-in calculator, etc.), open an email form, open hosted Kinetix (e.g., “for an animated tutorial, click here,” “test yourself,” etc.), add a new instance (such as a second driver for an auto insurance policy), open an independent application (e.g., “Click here to calibrate your monitor” or “Click here to download Adobe Acrobat”) and the like.

FIG. 24 illustrates a design screen for a Style Progress tic. Selecting the progress style “Pie with Tabs” provides all necessary support to produce a pie chart showing progress through the Kinetix, with tabs indicating each stage. Various stage tics are then entered to indicate progress through a given Kinetix. For example, the stage tics can be entered to show 0% progress prior to answering the first question in a stage, 25% progress when the first fourth of the questions have been answered, etc. By appropriate placement of the stage tics within the overall sequence of tics, the end-user's progress can readily be shown in the pie portion of the “Pie with Tabs” progress tic.

As discussed above, multiple Kinetix can be running concurrently. One will generally be the Host Kinetix, meaning that it controls modification of the database through the Data Dictionary. Other concurrently running Kinetix will generally be “Hosted,” meaning that they provide support to the Host Kinetix to which they are linked.

Continuing with the current auto insurance example, a Proactive Help Kinetix, such as an “Animated Assistance” type of Kinetix can be designed to provide contextual assistance to the end-user based upon the data entered thus far by the end-user. FIG. 25 illustrates the design screen for such a concurrently running Kinetix. This Kinetix is entitled “Proactive Help,” distinguishing it from the Auto Insurance Kinetix that runs in parallel. The Proactive Help Kinetix is “hosted” by the Auto Insurance Kinetix. By specifying the hosting Kinetix, the Proactive Help Kinetix determines what data are relevant. The Proactive Help Kinetix will generally involve a number of in-line rules to best provide the end-user with aid in completing the Host Kinetix. The Proactive Help Kinetix constantly checks end-user entered data to determine if its in-line rules evaluate True. Once an in-line rule within the Proactive Help Kinetix is True, the Proactive Help Kinetix provides guidance. As an example, the Proactive Help Kinetix can suggest an appropriate answer if the Data Dictionary indicates that the end-user entered data is not valid, and/or explain why the answer is not acceptable. While the Proactive Help Kinetix can suggest an appropriate answer, only the Host Kinetix, in this case the Auto Insurance Kinetix, can actually update the stored data, thereby ensuring the integrity of the database.

FIG. 26 depicts the end-user screen resulting from the operation of the tics depicted in FIGS. 14, 15, 16, 17, 19, 20, 23, 24, and 25.

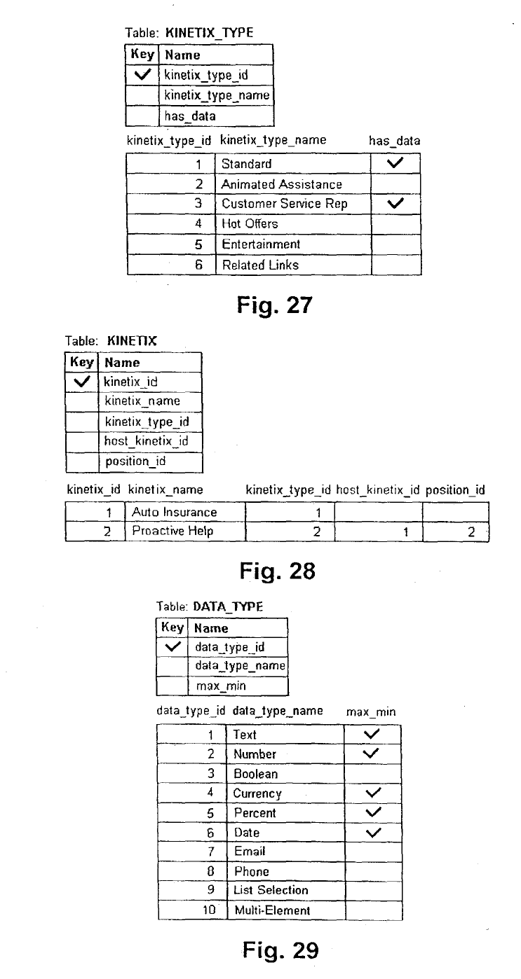

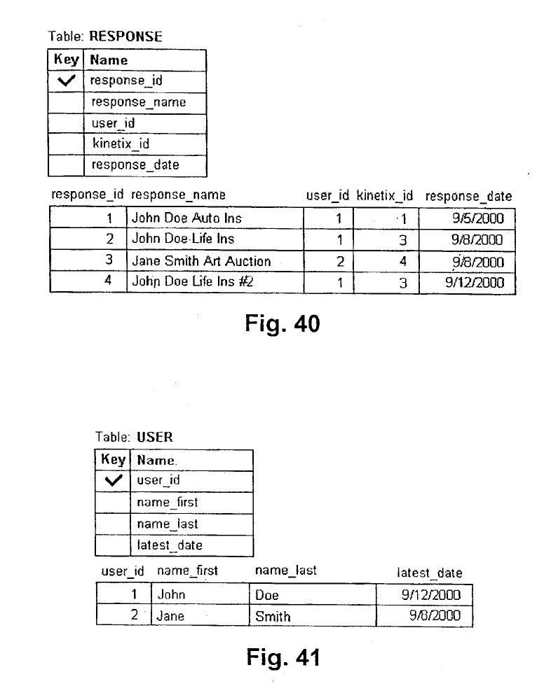

The underlying Kinetix Technology uses a data structure to support field positioning that involves the cooperative function of multiple tables. These tables are divided into two distinct groups: system design tables and user tables. System design tables support the design of a Kinetix System; user tables record end-user responses (i.e., data). FIGS. 27 through 39 show examples of Kinetix design tables, while FIGS. 40 through 43 are examples of Kinetix user tables.

A “KINETIX_TYPE” table (FIG. 27) identifies the various types of Kinetix supported by the system. This table can be expanded, adding more functionality with new releases of the Kinetix Technology software. Those Kinetix types that have data (i.e., the “has_data” flag is True), can operate independently. Those Kinetix types without their own data (i.e., contain no end-user provided responses), must rely on a Host Kinetix that does have data.

FIG. 27 illustrates six available Kinetix types within a Kinetix System. A “Standard” type asks questions of the end-user, and thus records user-entered data (“has_data”). The Auto Insurance Kinetix described above is an example of this type. The “Animated Assistance” type uses animation, to provide proactive assistance to the end-user, but does not record user-entered data.

A “Customer Service Rep” type uses pictures, audio, and/or video interaction with a real or virtual customer service representative (CSR). This interaction may be a combination of pushing pages, artificial intelligence, and chat room. The CSR can interact with pre-recorded, yet intelligent and personalized responses to the end-user's categorized and/or free-form questions. This type of Kinetix is capable of giving the illusion of real personal contact by taking advantage of decision-making rules and personalization data from the Host Kinetix.

“Hot Offers” type provides advertising in a portion of the screen, and becomes increasingly relevant as it learns more about the end-user. An “Entertainment” type provides relevant diversions on the screen, related to the current question or an end-user's response. The Entertainment type of Kinetix could present a cartoon, a joke, a trivia quiz question, or the like. A final Kinetix type in this example table is a “Related Links” type. As an example, the Related Links type of Kinetix could show a section entitled “For Further Information,” offering a rich end-user experience based on the questions currently being asked of the end-user, the end-user's responses, or both.

A “KINETIX” design table (FIG. 28) includes a list of the specific Kinetix currently selected for inclusion in a given Kinetix System, in this case the Auto Insurance Kinetix (the Host Kinetix) and the Proactive Help Kinetix (which is hosted by the Auto Insurance Kinetix).

A “DATA_TYPE” Kinetix design table (FIG. 29) identifies each of the different broad types of data defined in the system, and validations for each. For example, an Email data type must be of the form “<text>@<text>.<text>.” The DATA_TYPE table (FIG. 29) shows ten different data types by ID number and name, and indicates which data types have an associated maximum-minimum acceptable data range.

A “DATA_DICTIONARY” Kinetix design table is illustrated in FIG. 30. The DATA_DICTIONARY stores exact definitions for the data elements in a Kinetix System, and is used to provide consistent data format validations for the entire Kinetix System. As previously stated, the Data Dictionary does not store the actual data elements, though it is linked to the database tables in which the data elements are stored. Multiple Kinetix, and multiple tics within a single Kinetix, can refer to the same data element. For example, NAME_FIRST, the first data element in FIG. 30, is of the text data type (“1”) from the DATA_TYPE table, has a defined maximum character length of 30 and a minimum character length of 1.

A “VALIDATION” design table shown in FIG. 31 stores information for content validations that are applied to specific data elements in the Data Dictionary. In this example, the U.S. Area Codes validation rule can be applied to “Phone” data elements (FIG. 29), and ensures that the end-user entered area code is a currently valid U.S. area code.

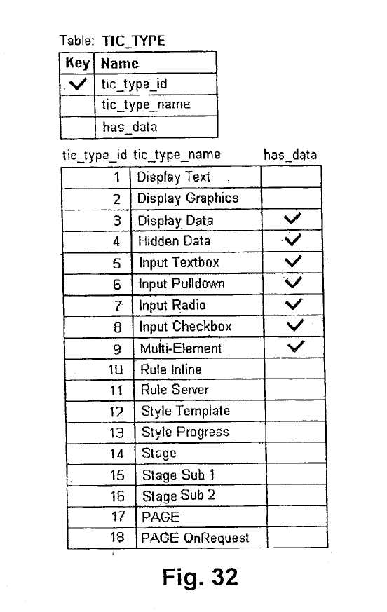

A “TIC_TYPE” design table (FIG. 32) identifies many of the key functionalities of Kinetix Technology. The table identifies various tic types in the Kinetix Technology library that may be used in constructing a Kinetix, though this list is not exhaustive and additional tic types can be created. The TIC_TYPE table includes a “has_data” flag that identifies which of the tic types has input data provided by the end-user. The “Display Text” and “Display Graphics” types of tics respectively display static text and images on the page. The text can have embedded HTML characters, including hyperlinks. A “Display Data” tic shows a single field from the database but does not require data input.

“Hidden Data” tics store data on a page for use with rules, and are not displayed to the end-user unless made visible by the action of a rule.

“Input” type tics display information to and retrieve information from the end-user and can pre-fill data in anticipation of data input. Input type tics include traditional types such as textbox, pulldown (e.g., single selection pulldown, multi-selection pulldown), listbox (e.g., single selection listbox, multi-selection listbox), radio button, and checkbox, as well as hybrid types, that include “multi-element” data. Multi-element data allows the programmer to create a data element that includes closely related data. As an example, a “birth date” multi-element input tic would include “birth month,” “birth day,” and “birth year” data elements, allowing the programmer to then apply characteristics to the combined data elements.

“Rule” tics provide logic and govern dependent (impacted) downstream tics: determining what questions will be asked, what pages will be displayed, format, content, and other dynamic changes. Rules are placed between condition upstream input tics and impact downstream tics. “In-line” rules operate on the client with the information available on the page. An in-line rule tic evaluates data immediately after it is entered. “Server” rules are evaluated on the server and thus evaluate the data after the page has been completed by the end-user and returned to the server.

“Style” tics change the overall look and feel of the page, including background images, type size and color, progress indicator, and breadcrumbs.

“Page” type tics demarcate a page without providing hyperlink assistance to get to that page. This is useful when a few key fields are always required before other questions are asked, e.g., asking a vehicle's year/make/model before asking further questions. Rather than permitting hyperlinks to a secondary page, the designer can force this first page to be seen again, and then navigate to subsequent pages by clicking the “Next” button.

“Page On Request” type tics are not navigable through the system supported “Next” “Back” buttons, but are presented when rules or other conditions dictate that they be displayed. For example, an “Accidents” page would only appear when the end-user answered Yes to having had an accident. A server rule would cause the Accidents page to appear next.

“TIC” table lists the tics that make up the Kinetix System, an example of which is shown in FIG. 33. This is the primary “working table” in Kinetix Technology. It stores all the Kinetix-designer's choices on how a Kinetix is constructed.

In FIG. 33, all the tics for the Auto Insurance Kinetix as well as the hosted Proactive Help Kinetix are listed. The tic_id (left column) records the order in which the tic information was entered, while the seq_no (third column from left) records the sequence in which these tics will actually be presented when the Kinetix is run. Fields tic_type_id, data_id, cols, cols_text, and text_value reference information described above. The fields style_id, graphic_{'}id, and text_posn_id are described below.

The text_value field serves as a visual label for input tics. For other tics, it may be a name or comment that appears only to help the designer.

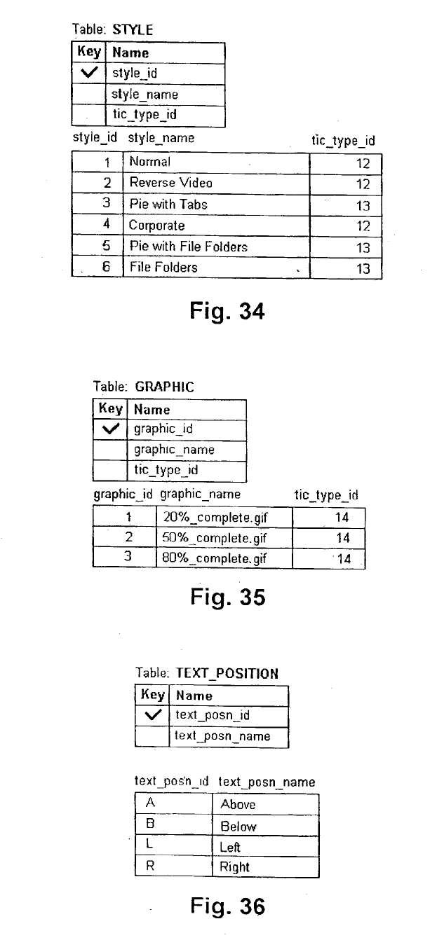

As previously noted, styles impact the look and feel or a page. FIG. 34 illustrates a “STYLE” design table with six styles, associated with the style template tic (type 12) or the style progress tic (type 13). Style Template tic options include normal, reverse video and corporate, while the Style Progress tic options include pie with tabs, pie with file folders, and file folders.

FIG. 35 illustrates an example “GRAPHIC” design table, used to store and make available graphic images such as corporate logo, illustrations of various types, graphs, and charts. The pie graphics, for example, are stored here.

“TEXT_POSITION” design table shown in FIG. 36 provides lookup values for positioning of text relative to its input control, such as textbox, pulldown, radio button, or checkbox. The table is also used for positioning a hosted Kinetix relative to a corresponding Host Kinetix.

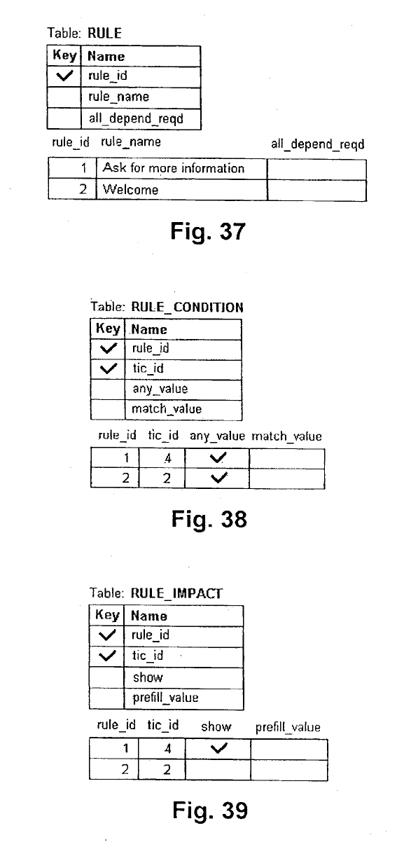

The various rules used within a Kinetix can be found in the “RULE” table, as illustrated in FIG. 37. If the all_depend_reqd field is True, then all conditions must evaluate True for the rule to evaluate True, as described above.

“RULE_CONDITION” design table, such as that shown in FIG. 38, lists all the conditions a given rule tic requires before the tic can evaluate True or False. If any_value is True, any non-null condition renders the rule True. If a match_value is specified, the value must match it exactly. Case sensitivity is typically not an issue, because match values are almost always taken from pulldown controls, which cannot be modified by the end-user.

The “RULE_IMPACT” table, illustrated in FIG. 39, follows the Rule_Condition table. The rule_impact table records all the changes that occur when a given rule tic evaluates True, or, conversely, the changes that are undone if the rule tic evaluates False. A value that had been modified when the rule tic was True may be restored if the rule tic is non-false.

The final group of tables relate to information provided to the Kinetix by various end-users. The “RESPONSE” table, shown in FIG. 40, identifies each end-user response and an associated date/time. Note that an end-user can have responses to several different Kinetix, as end-user John Doe does, in both the Life Insurance Kinetix and the Auto insurance Kinetix. An end-user can also have multiple interactions with the same Kinetix (at different times). In this example, John Doe accesses the Life Insurance Kinetix on two separate dates.

FIG. 41 illustrates an end-user table entitled “USER.” The user table stores the identities of any end-user of any Kinetix within a Kinetix System, and the date each end-user last accessed the Kinetix. The user table could easily be expanded, depending upon the needs of the Kinetix-developer. For example, the user table could include which Kinetix the end-user accessed or the end-user's address information.

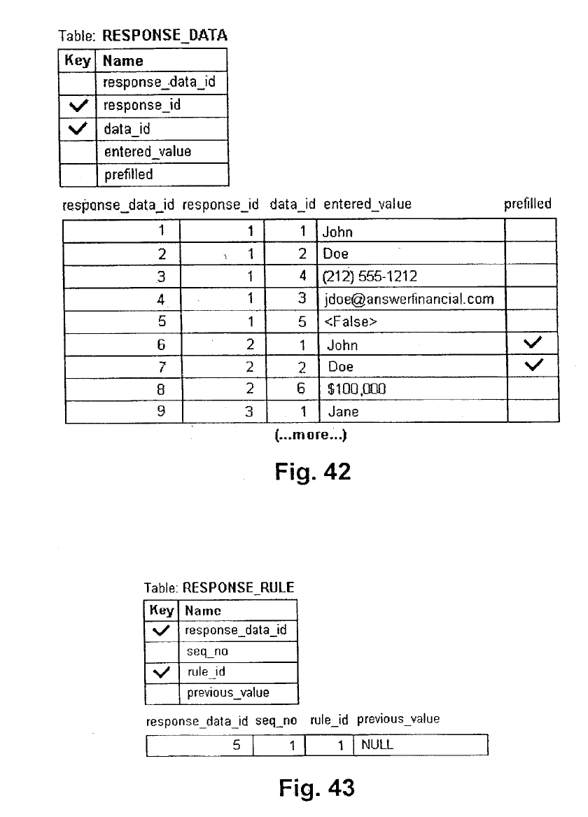

The “RESPONSE_DATA” table, shown in FIG. 42, is the main repository of end-user interaction, it stores all of an end-user's responses. The response data table does not reference a tic_id, only a data_id This assures that, for any individual end-user, only one answer is stored for any specific data item requested. For example, if the tic PHONE is completed by an end-user, then later pre-filled by a Kinetix, and altered by the end-user, the system will store only the altered version.

If the end-user is known, e.g., through previous logon or cookie mechanisms, the Kinetix automatically pre-fills any data items it has stored for this end-user. The automatic pre-fills will use data from the most recent response, if multiple responses have been collected. The pre-fill mechanism can be customized, however, to operate only when requested, or based upon a particular response or sets of responses. The pre-filled status is turned off if the Kinetix detects that the new data value is different from the original. Information that is obtained directly from the end-user is given precedence over pre-filled data.

The Kinetix uses the “RESPONSE_RULE” table illustrated in FIG. 43 to restore data values to end-user entered data if a rule tic currently evaluates False after having previously evaluated True. The rule_id field is set when a rule tic (either in-line or server) modifies data. Like the pre-filled status, the rule_id field is cleared if the current data value differs from the previously saved data value when the current data is saved. Similar to the pre-filled data, end-user entered data is given precedence over rule generated data. Another purpose served by the rule_id is if a condition is reversed, due to a related end-user response, the rule tic that set the data value can restore the data value to its previous value.

This corresponds to the example above in which an end-user from Massachusetts with no previous convictions caused the first rule tic to evaluate True, while the second rule tic regarding being from New York with no previous convictions evaluates as False. In this case, the impact of the second rule tic will not negate the first rule tic because the True value of the first rule tic caused an impact and was recorded in the Response_Rule table. As the second rule tic that evaluated as False did not cause an impact, its result was not recorded in the Response Table. However, if at some later time neither rule tic evaluates as True, the original field data value can be restored.

Based upon the above description of tic construction and the various tables, the operation of a Kinetix will now be explored in greater detail. For the purpose of illustration, a server application is described though a single-user computer or other mechanism may be employed to run the Kinetix.

A server starts running a Kinetix when it receives the appropriate request from an end-user. The server begins processing each tic in the tic table in the specified sequence for the requested Kinetix. If the Kinetix has one or more associated Hosted Kinetix, the Hosted Kinetix are processed as well.

The server builds a page and within this page puts a 12-column table assuming the Kinetix is based upon the 12-column table format. The server adds controls to the page based on the tic sequence, the tic types, and the dimensions associated with each of the tics. This process continues until a progress tic, such as a stage or page tic is encountered, or there are no more tics in the Kinetix. Due to the underlying Kinetix Technology, “Next” and “Back” buttons appear automatically. Clicking on the “Next” or “Back” buttons updates internal data stored in hidden data fields on the page. The server knows to not put a “Back” button on the first page, or a “Next” button on the last page. The page is then submitted to the client.

As just noted, some hidden data fields for storing system management information may exist within the page. These hidden data fields are not specified by the Kinetix-developer, but are a portion of the underlying Kinetix Technology. The hidden data fields inform the system what stage or page the system is currently on, and based upon what button or hyperlink an end-user presses, what stage or page the Kinetix goes to next. The hidden data fields also provide the Kinetix with the type of action that the system is taking. Possible actions include navigate (default) or one of several other processes. These other processes include adding, editing, or deleting an instance, for example, one of several drivers for an Auto Insurance Kinetix or subinstance, for example, each of the several drivers could have multiple accidents.

When returning from the first or any subsequent page, information is passed in the form of system hidden data fields to the Kinetix. If one or more data fields fail during validation, the same page is redrawn (entire page or just invalid tics) with appropriate error and help messages. When all data field validations pass successfully, the appropriate action is taken and the next page is drawn.

Once control has returned to the server, server rule tics are evaluated using all data available to the system. The available data must sequentially precede the rule, and may include data from previous sections or pages. The rule tics also determine which subsequent tics are shown, and may navigate to additional pages that are not normally in the “Next”/“Back” path. These additional pages can include page on request types, where at least one input tic must be shown on these pages for the page to appear.

During page construction, a style template tic may be specified. The style template may be defined in Dynamic Hypertext Markup Language (DHTML), using cascading style sheets. If additional style template tics are encountered in the sequence, the cascading style sheets being referenced will change. Some of these styles will include background and other graphic images that will be maintained by the system.

Progress indicators and breadcrumbs using progress pie charts, thermometers, or other approaches will use the graphic indicated in the stage, stage sub 1, or stage sub 2 tics. Names (text values) for corresponding tics will appear in the tabs or hyperlinks. These hyperlink values do not necessarily point to another page or tag (as is typical), but rather may launch a client-side JavaScript program, which stores target values as hidden controls in a page. The underlying Kinetix technology on the server uses the target value information to determine where the Kinetix should go next.

Maintaining a large interactive web site is difficult because many separate web pages must be written. Each web page has its own possibilities for errors, and each should be tested separately. Unlike manually generated pages, Kinetix Technology regenerates the same page repeatedly, populating its contents from the Kinetix tic sequence. In Kinetix, only one web page is used, which calls itself endlessly, in a loop. This greatly reduces the possibility of syntax and coding logic errors. Since the Kinetix is constructed from discrete tic building blocks, the Kinetix-developer's principle concern is business logic errors (e.g., Are we asking good questions?).

A hosted Kinetix, such as animated assistance, hot offers, entertainment, and related links, may be operated using client-side JavaScript. Using the OnChange event of input tics, which occurs when the end-user changes the data value of an input tic, a local script runs to see if any hosted Kinetix is affected. If so, the system causes the desired effect. Note that the system ensures that all data necessary for an in-line rule to be evaluated is present on the page, and that the hosted Kinetix also use in-line rules.

The previous examples have been directed toward Internet applications, but Kinetix Technology is not limited to this. Kinetix Technology can find use in desktop applications as well, especially database applications requiring data entry of various types. Kinetix Technology is also applicable to audio or even tactile applications. Telemarketing and automated telephone answering services can each benefit from the dynamic management capabilities of Kinetix Technology.

In each of the provided examples and potential applications, Kinetix Technology provides substantial benefit in applications that require acquiring a significant amount of information from the end-user. As an example, a questionnaire may require the end-user to enter data in response to numerous questions. This intensive end-user interaction can be reduced because the questionnaire can be dynamically tailored to the specific end-user based upon the end-user's input. In other applications, Kinetix Technology adds value to the process of dispensing data, since tailoring downstream portions according to values entered in upstream portions allows unlimited one-to-one personalization. For example, in a teaching program, a small amount of system-user interaction can determine user strengths and weaknesses, then focus downstream portions on correcting those weaknesses.

What follows is an example of code (C++) to draw an Input Type Tic on an HTML page, entitled AF_SP_Draw_Data. Operating within the larger framework of Kinetix Technology, this code draws a textbox, hidden textbox, pulldown, radio button, or checkbox, depending on the tic type. It receives as inputs various parameters from a calling function, AF_SP_Draw( ), for which include @af_{'}data_id, uniquely identifies this tic in the Data Dictionary, and @entered_value records the end-user's response for this tic, or its pre-filled value if the end-user has not yet seen the tic. More complex types, such as pulldowns and display types, call other routines, not shown here. This particular code is written as a Microsoft SQL Server 7.0 stored procedure, though other platforms are envisioned.

[image]

[image]

[image]

[image]

[image]

[image]

[image]

What is claimed is:

1. A method using a computer system for developing an application program, the method comprising the steps of:
defining a set of tics;
defining a data dictionary wherein data elements are associated with at least one of said tics; and
defining a standardized interaction between said tics so as to allow said tics to be assembled in a sequence to form said application program, wherein assembly of said tics in said sequence is performable without interaction with a programing language, and wherein said standardized interaction is based in part on a position of said tic in said sequence.

2. A method as recited in claim 1, wherein said application program is adapted to request only said data associated with said data elements required by said application program.

3. A method as recited in claim 1, wherein said data associated with said data elements are stored in one location and are controlled by said data dictionary.

4. A method as recited in claim 1, wherein said method is employable to create multiple related application programs, each of said related application programs sharing said data dictionary.

5. A method as recited in claim 4, wherein each of said multiple related application programs are adapted to request only those data elements that have not already been received by another of said related application programs.

6. A method as recited in claim 4, wherein said data dictionary allows said data elements to be used by said multiple related application programs.

7. A method as recited in claim 1, wherein said data dictionary allows said data elements to be used in multiple locations within said application program.

8. A method using a computer system for the creation of an application program, comprising the steps of:
selecting a tic from a library of tics, each of said tics having a predetermined functionality;
configuring said tic; and
placing said tic in a sequence to form said application program, said predetermined functionality of each of said tics being based on a position of said tic in said sequence.

9. A method as recited in claim 8, further comprising the steps of:
creating a tic;
applying a tic type from a library of tic types to said tics, said tic thus having said predetermined functionality.

10. A method as recited in claim 8, wherein a Kinetix-developer may create said application program without interacting with a programming language.

11. A method as recited in claim 8, wherein said library contains tics selected from the group consisting of:
input tics,
display tics;
section formatting tics;
function tics; and
rule tics.

12. A method as recited in claim 8, wherein the step of configuring comprises the step of positioning said tic within a page.

13. A method as recited in claim 8, wherein the step of configuring comprises the step of applying sizing and formatting characteristics to said tic.

14. A method as recited in claim 8, wherein the step of configuring comprises the step of associating said tic with a rule as defined in a rule library.

15. A method as recited in claim 8, wherein multiple application programs thusly constructed may operate concurrently.

16. A method as recited in claim 8, wherein the step of configuring comprises the step of associating said tic with a data element as defined in a data dictionary.

17. A method as recited in claim 16, wherein multiple application programs thusly constructed may share information by sharing said data dictionary.

18. A method as recited in claim 17, wherein said data dictionary maintains data integrity for said multiple application programs without requiring additional programming constructs.

19. A method as recited in claim 17, wherein a number of said multiple application programs may control modification of a database through said data dictionary.

20. A method as recited in claim 8, wherein said application program is an interactive voice response (IVR) program.

21. A method for the dynamic collection of information from an end-user by use of a computer system, comprising the steps of:
maintaining a sequence of tics in said computer system, each of said tics having a particular function based in part on its position in said sequence, a number of said tics being input tics, each having an associated data element;
forming a page from a set of said tics, including at least one of said input tics;
transmitting said page to an end-user terminal; and
receiving, from said end-user, data corresponding to said data element associated with said at least one input tic.

22. A method as recited in claim 21, wherein said at least one input tic in said set further has an end-user interface, said page employing said end-user interface to request said data from said end-user.

23. A method as recited in claim 22, wherein said end-user interface includes
a question to be answered; and
formatting information.

24. A method as recited in claim 21, wherein said at least one input tic employs an interface construct selected from the group consisting of:
a textbox;
a pulldown;
a listbox;
a checkbox; and
a radio button.

25. A method as recited in claim 21, wherein a tic in said set is a display tic that includes an element selected from the group consisting of:
text;
a logo;
an illustration;
a photograph;
a border,
a background;
a sound clip; and
a video clip.

26. A method as recited in claim 21, wherein said set is a first set and said page is a first page, said method further comprising the steps of:
forming a second page from a second set of said tics, and
transmitting said second page to said end-user terminal.

27. A method as recited in claim 26, wherein a tic in said first set is a page break tic that separates said first set from said second set.

28. A method as recited in claim 21, wherein said computer system is a strand-alone computer system, said end-user terminal being a part of said computer system.

29. A method as recited in claim 21, wherein said computer system is a server of a client-server system, said end-user terminal being a client of said client-server system.

30. A method as recited in claim 21, wherein said page is a web page.

31. A method as recited in claim 21, wherein said page includes HTML code.

32. A method in accordance with claim 21, wherein said at least one input tic in said set is adapted to deliver kinesthetic information to and/or receive kinesthetic information from said end-user so as to train said end-user to move as programmed.

33. A method for the dynamic collection of information from an end-user by use of a computer system, comprising the steps of:
maintaining a sequence of tics in said computer system, each of said tics having a function based on its position in said sequence, a number of said tics being input tics, each having an associated data element;
transmitting to an end-user terminal a page formed from a set of said tics; including at least one of said input tics, said page requesting data from said end-user; and
receiving, from said end-user, said data corresponding to said data element associated with said at least one input tic, said data thus employable by others of said tics occurring subsequent to said at least one input tic.

34. A method as recited in claim 33, wherein said sequence of tics is a first sequence, said method further comprising the step of maintaining a second sequence of tics in said computer system, said first and second sequences sharing a common data dictionary that maintains data integrity of said first and second sequences.

35. A method as recited in claim 34, further comprising the steps of:
storing said data in a database associated with said computer system and controlled by said data dictionary; and
recalling said data for use with said second sequence so as to avoid repeated requests for said data from said end-user.

36. A method as recited in claim 33, further comprising the step of validating said data to determine whether said data conforms to a predetermined criteria associated with said data element.

37. A method as recited in claim 36, further comprising the step of re-requesting said data from said end-user if said data does not conform to said predetermined criteria.

38. A method using a computer system for the dynamic collection of information from an end-user at an end-user terminal, comprising the steps of:
maintaining in said computer system a plurality of tics, including input tics each having a corresponding data element, and rule tics each having at least a corresponding action;
transmitting to said end-user terminal a page formed from a set of said tics, including at least one of said input tics;
receiving, from said end-user, data relating to said data element for each of said input tics in said set;
applying a portion of said data received to one of said rule tics associated with said set to modify at least one subsequent tic in said first set in accordance with said corresponding action of said rule tic; and [_{KW1}]
changing at least a portion of said page based on the modification.

39. A method as recited in claim 38, wherein said rule tic runs on said end-user terminal to change said page.

40. A method as recited in claim 39, further comprising the step of initiating a second sequence of tics as a function of said rule tic.

41. A method as recited in claim 40, further comprising the step of providing guidance to said end-user via said second sequence of tics.

42. A method as recited in claim 38, wherein said rule tic is capable of performing at least one function selected from the group consisting of:
causing at least one subsequent tic to become visible or invisible to the end-user;
changing a value of at least one subsequent tic;
associating a different pulldown with at least one subsequent input tic;
re-populating pulldown elements associated with at least one subsequent input tic;
re-ordering a sequence of said subsequent tics; and
causing a subordinate sequence of tics to become active.

43. A method using a computer system for the dynamic collection of information from an end-user at an end-user terminal, comprising the steps of:
maintaining in said computer system a plurality of tics, including input tics each having at least one corresponding data element, and rule tics each having at least one corresponding action;
transmitting to said end-user terminal a first page formed from a first set of said tics, including at least one of said input tics;
receiving, from said end-user, data relating to said data element for each of said input tics in said first set;
applying at least a portion of said data received to one of said rule tics associated with said first set to modify at least one tic in a subsequent set of said tics in accordance with said corresponding action of said rule tic;
transmitting to said end-user terminal a subsequent page formed based on the modification; and
receiving, from said end-user, data relating to said data element for each input tic in said subsequent set.

44. A method as recited in claim 43, wherein said rule tic runs on said computer system to affect said subsequent page transmitted to said end-user terminal.

45. A method, using a computer system, for the dynamic collection of information from an end-user at an end-user terminal, comprising the steps of:
maintaining in said computer system a sequence of tics, including input tics each having a corresponding data element, and rule tics each having a corresponding action;
transmitting to said end-user terminal a page formed from a set of said tics, including at least one of said input tics, said page requesting data from said end-user;
receiving, from said end-user, said data corresponding to said data element associated with said at least one input tic;
applying said data to one of said rule tics associated with said set to determine whether said data conforms to a predetermined criteria associated with said data element; and
re-requesting said data from said end-user if said data does not conform to said predetermined criteria.

46. A method as recited in claim 45, wherein said computer system is a server of a client-server system, said end-user terminal being a client of said client-server system, said rule tic running on said server.

47. A method as recited in claim 45, wherein said computer system is a server of a client-server system, said end-user terminal being a client of said client-server system, said rule tic running on said client.

48. A method as recited in claim 47, wherein a tic in said set is a page break tic that sends said data to said server if said data conforms to said predetermined criteria.

49. A method as recited in claim 45, wherein said sequence of tics is a first sequence, said method further comprising the step of initiating a second sequence of tics that provides guidance to said end-user.

50. A method as recited in claim 49, wherein said second sequence of tics is hosted by said first sequence.

51. A method as recited in claim 49, wherein said first and second sequences share a common data dictionary that maintains data integrity of said first and second sequences.

52. A method using a computer system for the dynamic collection of information from an end-user at an end-user terminal, comprising the steps of
maintaining in said computer system a sequence of tics, including input tics each having a corresponding data element, and rule tics each having a corresponding action;
transmitting to said end-user terminal a page formed from a set of said tics, including at least one of said input tics, said page requesting data from said end-user;
receiving, from said end-user, said data corresponding to said data element associated with said at least one input tic; and
applying said data to at least one of said rule tics associated with said set to determine whether tics subsequent to said rule tic are to be modified.

53. A method as recited in claim 52, wherein said rule tic is capable of performing at least one function selected from the group consisting of:
causing at least one subsequent tic to become visible or invisible to the end user;
changing a value of at least one subsequent tic;
associating a different pulldown with at least one subsequent input tic;
re-populating pulldown elements associated with at least one subsequent input tic;
reordering a sequence of said subsequent tics; and
causing a subordinate sequence of tics to become active.

54. A method as recited in claim 52, further comprising the step of causing a portion of subsequent tics to be visible and another portion of said subsequent tics to be invisible so as to avoid presenting questions that arc inapplicable to said end-user.

55. A method as recited in claim 52, further comprising the step of calculating data values for subsequent tics based on said data received from said end-user.

56. A method as recited in claim 52, further comprising the step of pre-filling subsequent tics with values based on said data received from said end-user.

57. A method as recited in claim 52, wherein said rule tic is a transformation rule, said method further comprising the step of classifying said data received from said end-user into one of a plurality of categories.

58. A method as recited in claim 52, wherein said rule tic is a transformation rule, said method farther comprising the step of parsing said data received from said end-user into a plurality of database fields.

59. A method using a computer system for the dynamic collection of information from an end-user at an end-user terminal, comprising the steps of:
maintaining in said computer system a plurality of tics, including input tics each having a corresponding data element, rule tics each having a corresponding action, and page break tics;
selecting a first set of said tics, including at least one of said input tics and concluding with one of said page break tics;
transmitting said first page to said end-user terminal, said first page being formed from said first set;
receiving, from said end-user terminal, data corresponding to said data element for each respective input tic in said first set;
applying at least a portion of said data thus received to at least one of said rule tics to modify at least one subsequent input tic in accordance with a corresponding action of said rule tic;
selecting a subsequent set of said tics, including at least one of said input tics and concluding with another one of said page break tics, wherein at least one of said tics in said subsequent set has been modified by said at least one of said rule tics;
transmitting said subsequent page to said end-user terminal, said subsequent page being formed from said subsequent set; and
receiving, from said end-user terminal, data corresponding to said data element for each respective input tic in said subsequent set.

60. A method as recited in claim 59, wherein said tics are organized in sequential sets, each of said tics having a universal interface for interfacing with others of said tics, said universal interface defining data exchange rules for said tics.

61. A method as recited in claim 59, further comprising the step of storing said data in a database associated with said computer system.

62. A method as recited in claim 61, further comprising the step of pre-filling at least one of said subsequent tics with said data stored in said database.

63. A method as recited in claim 59, further comprising the step of pre-filling at least one of said subsequent tics with values based upon sets of criteria effected by rule logic.

64. A method as recited in claim 59, wherein at least one of said tics is hidden from said end-user.

65. A method as recited in claim 59, wherein a function of one of said tics is to display progress indications to said end-user.

66. A method as recited in claim 59, wherein a function of one of said tics is to create tabs to delineate sub-sections composed of one or more tics.

67. A method as recited in claim 59, wherein a function of one of said tics is to create expandable tree-like folders within a section that permit hyperlinks back to more specific parts of said section.

68. A method as recited in claim 59, wherein a function of one of said tics is to classify said data received from said end-user into one of a plurality of categories.

69. A method as recited in claim 59, wherein one of said tics employs an interface construct selected from the group consisting of:
a textbox;
a pulldown;
a checkbox; and
a radio button.

70. A method as recited in claim 59, wherein said end-user terminal includes an output device capable of providing an end-user interface in a form selected from the group consisting of:
a visual form;
an aural form;
an olfactory form;
a tactile form;
a gustatory form; and
a kinesthetic form.

71. A method as recited in claim 59, wherein one of said tics is employed to link said end-user to additional information.

72. A method using a computer system for the dynamic exchange of information with an end-user at an end-user terminal, comprising the steps of:
maintaining in said computer system a plurality of tics, including input tics each having a corresponding data element, and rule tics each having at least a corresponding action;
transmitting to said end-user terminal a page formed from a set of said tics, including at least one of said input tics;
receiving, from said end-user, data relating to said data element for each of said input tics in said set;
applying a portion of said data received to one of said rule tics associated with said set to modify at least one subsequent tic in said first set in accordance with said corresponding action of said rule tic; and[KW2]
changing at least a portion of said page based on the modification so as to provide said end-user with information based on said data received.

73. A method as recited in claim 72, wherein said rule tic is capable of performing at least one function selected from the group consisting of:
causing at least one subsequent tic to become visible or invisible to the end-user;
changing a value of at least one subsequent tic;
associating a different pulldown with at least one subsequent input tic;
re-populating pulldown elements associated with at least one subsequent input tic;
re-ordering a sequence of said subsequent tics; and
causing a subordinate sequence of tics to become active.

74. A method as recited in claim 72, wherein said information thus provided to said end-user is kinesthetic information.

75. A method as recited in claim 72, wherein said information thus provided to said end-user is used to train said end-user.

76. A method using a computer system for the dynamic exchange of information with an end-user at an end-user terminal, comprising the steps of:
maintaining in said computer system a plurality of tics, including input tics each having at least one corresponding data element, and rule tics each having at least one corresponding action;
transmitting to said end-user terminal a first page formed from a first set of said tics, including at least one of said input tics;
receiving, from said end-user, data relating to said data element for each of said input tics in said first set;
applying at least a portion of said data received to one of said rule tics associated with said first set to modify at least one tic in a subsequent set of said tics in accordance with said corresponding action of said rule tic; and
transmitting to said end-user terminal a subsequent page formed based on the modification, wherein said subsequent page provides said end-user with information based on said data received.

77. A method as recited in claim 76, wherein said rule tic is capable of performing at least one function selected from the group consisting of:
causing at least one subsequent tic to become visible or invisible to the end-user;
changing a value of at least one subsequent tic;
associating a different pulldown with at least one subsequent input tic;
re-populating pulldown elements associated with at least one subsequent input tic;
re-ordering a sequence of said subsequent tics; and
causing a subordinate sequence of tics to become active.

78. A method as recited in claim 76, wherein said information thus provided to said end-user is kinesthetic information for training said end-user to move as programmed.
